(19) United States
(12) Patent Application Publication
(10) Pub. No.: US 2026/0184868 A1
(43) Pub. Date: Jul. 2, 2026

(54) FILMS WITH IMPROVED TEAR STRENGTH

(71) Applicant: Eastman Chemical Company, Kingsport, TN (US)

(72) Inventors: Brandon Robert Williamson, Johnson City, TN (US); Sophie Ann Ruddick, Liverpool (GB); Mark Allen Peters, Telford, TN (US)

(73) Assignee: Eastman Chemical Company, Kingsport, TN (US)

(21) Appl. No.: 19/130,141

(22) PCT Filed: Nov. 17, 2023
(86) PCT No.: PCT/US2023/080239

§ 371 Date: May 15, 2025

Related U.S. Application Data
(60) Provisional application No. 63/385,423, filed on Nov. 30, 2022.

(51) Int. Cl. C08J 5/18; C08L 67/02

(52) U.S. Cl. CPC C08J 5/18; C08L 67/02; C08J 2367/02; C08J 2467/02; C08L 2203/16

(57) ABSTRACT

Provided are copolyester films comprising isophthalic acid residues which exhibit improved tear strength which can be useful in many applications, including formed articles for use in the dental appliance market.

### FIELD OF THE INVENTION

This invention belongs generally to the field of thermoplastic polymers. In particular, it relates to polymeric films useful in the manufacture of three-dimensional thermoformed articles, such as dental appliances.

### BACKGROUND OF THE INVENTION

Traditionally, metal braces have been used to reposition teeth for improved function or appearance. In recent years, metal braces have been supplanted in many cases by plastic aligners. Aligners may be thermoformed to create a device which fit over the patient's teeth, designed to gradually move them to a new, more desired position. Aligners must be stiff enough to exert an initial force on the teeth and be durable enough resist cracking in use (including inserting onto and removal from the teeth). The ability of the aligner to resist tearing during processing and handling is also a key criteria.

Aligners can be made from a monolayer plastic sheet, but multilayer sheet (consisting of two or more distinct layers of plastic) can allow more freedom to tailor properties to specific needs. However, multilayer sheet manufacturing processes can be more difficult or more cost-intensive than a monolayer.

It would be beneficial to provide films or sheets having improved or a wider latitude for tailoring properties compared to current monolayer or multilayer sheets.

### SUMMARY OF THE INVENTION

It has been discovered that selection of a monolayer film containing isophthalic acid (IPA) may result in a more tear resistant aligner. In embodiments, a monolayer film can be provided that allows more freedom to tailor properties to specific needs without the added complexity of multilayer film extrusion.

It has also been found that blending polymers containing isophthalic acid in a structure having one component with a suitably chosen second component (in the same film/layer) allows the ability to tailor the overall structure's physical properties while maintaining the desired tear resistance and clarity.

The invention is as set forth in the appended claims. In general, the invention relates to film structures which exhibit improved resistance to tearing while maintaining clarity which can be useful in many applications, including thermoformed articles for use in the dental appliance market. The modulus can also be tailored to fit the needs of the end user by altering the material selection and the thickness of the film or layer(s). These structures can be produced through extrusion, lamination, or other means known to those skilled in the art.

In an aspect, film structures are provided that comprise either a single copolyester or multicomponent composition. In embodiments, the multicomponent composition comprises at least two polymer components (A) and (B) that are different. In embodiments, polymer component (A) is present in an amount from 40 to 99 wt %, or 50 to 99 wt %, or greater than 50 to 99 wt %, and polymer component (B) is present in an amount from 1 to 60 wt %, or 1 to 50 wt %, or 1 to less than 50 wt %. In embodiments, the film is a monolayer structure. In other embodiments, the film is a multilayer structure that comprises one or more layers that comprises a multicomponent composition.

### DETAILED DESCRIPTION OF THE INVENTION

The term “film”, as used herein, includes both film and sheet, and is intended to have its commonly accepted meaning in the art.

As used herein, the singular forms “a”, “an”, and “the” include their plural referents unless the context clearly dictates otherwise. The terms “containing” or “including” are intended to be synonymous with the term “comprising”, meaning that at least the named compound, element, particle, or method step, etc., is present in the composition or article but does not exclude the presence of other compounds, materials, method steps, etc., even if the other such compounds, material, particles, method steps, etc., have the same function as what is named, unless expressly excluded in the claims.

In an aspect, a film is provided that comprises a copolyester comprising:
(a) a dicarboxylic acid component comprising:
   i) 1 to 100 mole % of isophthalic acid residues; and
   ii) 0 to 99 mole % of terephthalic acid residues; and
   iii) 0 to 25 mole % of a different aromatic and/or aliphatic dicarboxylic acid residues having up to 20 carbon atoms; and
(b) a glycol component comprising:
   i) 50 to 100 mole % of 1,4-cyclohexanedimethanol residues; and
   ii) 0 to 50 mole % of ethylene glycol residues; and
   iii) 0 to 25 mole % of a different aromatic and/or aliphatic modifying glycol residues;
having an inherent viscosity of about 0.4 to about 1.1 dL/g as determined in 60/40 (wt/wt) phenol/tetrachloroethane at a concentration of 0.5 g/100 ml at 25° C.

In embodiments, a film is provided that comprises a copolyester comprising:
(a) a dicarboxylic acid component comprising:
   i) 1 to 50 mole % of isophthalic acid residues; and
   ii) 50 to 99 mole % of terephthalic acid residues;
(b) a glycol component comprising:
   i) 1,4-cyclohexanedimethanol residues;
having an inherent viscosity of about 0.4 to about 1.1 dL/g as determined in 60/40 (wt/wt) phenol/tetrachloroethane at a concentration of 0.5 g/100 ml at 25° C. In another embodiment, the inherent viscosity ranges from about 0.6 to about 1.0.

In embodiments, a film is provided that comprises a multicomponent composition, said multicomponent composition comprising at least two polymeric components (A) and (B), that are different from each other. In embodiments, polymeric component (A) is present in an amount from 40 to 99 wt %, or greater than 40 to 99 wt %, or 50 to 99 wt %, or greater than 50 to 99 wt % and polymeric component (B) is present in an amount from 1 to 60 wt %, or 1 to less than 60 wt %, or 1 to 50 wt %, or 1 to less than 50 wt %. In embodiments, the polymeric component (A) comprises a polyester that comprises:
(a) a dicarboxylic acid component comprising:
   i) 1 to 100 mole % of isophthalic acid residues; and
   ii) 0 to 99 mole % of terephthalic acid residues; and
   iii) 0 to 25 mole % of a different aromatic and/or aliphatic dicarboxylic acid residues having up to 20 carbon atoms; and
(b) a glycol component comprising:
   i) 50 to 100 mole % of 1,4-cyclohexanedimethanol residues; and
   ii) 0 to 50 mole % of ethylene glycol residues; and
   iii) 0 to 25 mole % of a different aromatic and/or aliphatic modifying glycol residues;
having an inherent viscosity of about 0.4 to about 1.1 dL/g as determined in 60/40 (wt/wt) phenol/tetrachloroethane at a concentration of 0.5 g/100 ml at 25° C.; and
polymeric component (B) comprises a polyester which is other than the polyester in polymeric component (A).

In embodiments, polymeric component (B) comprises a polyester that comprises:
(a) a dicarboxylic acid component comprising:
   i) 50 to 100 mole % of terephthalic acid residues;
   ii) 0 to 50 mole % of isophthalic acid residues; and
(b) a glycol component comprising:
   i) 1 to 100 mole % of 1,4-cyclohexanedimethanol residues; and
has an inherent viscosity of about 0.4 to about 1.0 dL/g as determined in 60/40 (wt/wt) phenol/tetrachloroethane at a concentration of 0.5 g/100 ml at 25° C. In another embodiment, the inherent viscosity ranges from about 0.6 to about 0.8.

In embodiments, polymeric component (B) comprises a polyester that comprises:
(a) a dicarboxylic acid component comprising:
   i) 50 to 100 mole % of terephthalic acid residues;
   ii) 0 to 50 mole % of isophthalic acid residues; and
(b) a glycol component comprising:
   i) 1 to 100 mole % of 1,4-cyclohexanedimethanol residues; and
   ii) 0 to 99 mole % of ethylene glycol residues; and
has an inherent viscosity of about 0.4 to about 1.0 dL/g as determined in 60/40 (wt/wt) phenol/tetrachloroethane at a concentration of 0.5 g/100 ml at 25° C. In another embodiment, the inherent viscosity ranges from about 0.6 to about 0.8.

In embodiments, polymeric component (B) comprises a polyester that comprises:
(a) a dicarboxylic acid component comprising:
   i) 50 to 100 mole % of terephthalic acid residues;
   ii) 0 to 50 mole % of isophthalic acid residues; and
(b) a glycol component comprising:
   i) 30 to 100 mole % of 1,4-cyclohexanedimethanol residues; and
   ii) 0 to 70 mole % of 2,2,4,4-tetramethyl-1,3-cyclobutanediol residues; and
      has an inherent viscosity of about 0.4 to about 0.9 dL/g as determined in 60/40 (wt/wt) phenol/tetrachloroethane at a concentration of 0.5 g/100 ml at 25° C. In another embodiment, the inherent viscosity ranges from about 0.6 to about 0.8.

In embodiments, polymeric component (B) comprises a polyester that comprises:
(a) a dicarboxylic acid component comprising:
   i) 1 to 100 mole % of 1,4-cyclohexanedicarboxylic acid residues; and
(b) a glycol component comprising:
   i) 1 to 100 mole % of 1,4-cyclohexanedimethanol residues; and
has an inherent viscosity of about 0.4 to about 0.9 dL/g as determined in 60/40 (wt/wt) phenol/tetrachloroethane at a concentration of 0.5 g/100 ml at 25° C. In another embodiment, the inherent viscosity ranges from about 0.6 to about 0.8.

In embodiments, polymeric component (B) comprises a polyester that is a polyesterether. In embodiments, the polyesterether comprises:
(a) a dicarboxylic acid component comprising:
   i) 1 to 100 mole % of 1,4-cyclohexanedicarboxylic acid residues; and
(b) a glycol component comprising:
   i) 1 to 99 mole % of 1,4-cyclohexanedimethanol residues; and
   ii) 1 to about 50 mole percent, or from 1 to 20 mole percent, or from 1 to 15 mole percent, or from 2 to 10 mole percent, based on the moles of the glycol component of the polyesterether, of polytetramethyleneether glycol (PTMG) having a weight average molecular weight of about 500 to about 2000; and
has an inherent viscosity of about 0.7 to about 1.5 dL/g as determined in 60/40 (wt/wt) phenol/tetrachloroethane at a concentration of 0.5 g/100 ml at 25° C.

In another embodiment, the multicomponent composition comprises three polymer components (A), (B) and (C) where the polymer components are different. In embodiments for the three-component composition, polymeric component (A) is present in an amount from 40 to 99 wt %, or greater than 40 to 99 wt %, or 50 to 99 wt %, or greater than 50 to 99 wt % and polymeric components (B) and (C) are each present in an amount from 1 to 60 wt %, or 1 to less than 60 wt %, or 1 to 50 wt %, or 1 to less than 50 wt %. In embodiments for the three-component composition, the polymeric component (A) can be a polyester as described herein for component (A) in embodiments for the (at least) two component composition and components (B) and (C) can independently be a polyester or copolyester as described herein for component (B) in the embodiments for the (at least) two component composition, with the proviso that components (B) and (C) are different.

In embodiments for the three-component composition, polymeric component (A) comprises a polyester that comprises:
(a) a dicarboxylic acid component comprising:
   i) 1 to 100 mole % of isophthalic acid residues; and
   ii) 0 to 99 mole % of terephthalic acid residues; and
   iii) 0 to 25 mole % of a different aromatic and/or aliphatic dicarboxylic acid residues having up to 20 carbon atoms; and
(b) a glycol component comprising:
   i) 50 to 100 mole % of 1,4-cyclohexanedimethanol residues; and
   ii) 0 to 50 mole % of ethylene glycol residues; and
   iii) 0 to 25 mole % of a different aromatic and/or aliphatic modifying glycol residues;
having an inherent viscosity of about 0.4 to about 1.1 dL/g as determined in 60/40 (wt/wt) phenol/tetrachloroethane at a concentration of 0.5 g/100 ml at 25° C.; and polymeric components (B) and (C) each comprise a polyester which is other than the polyester in polymeric component (A), with the proviso that components (B) and (C) are different from each other.

In other embodiments (for any of the embodiments described herein in this application), the polymeric component (A) is a polyester that comprises:
(a) a dicarboxylic acid component comprising:
   i) 1 to 100 mole % of isophthalic acid residues; and
   ii) 0 to 99 mole % of terephthalic acid residues; and
   iii) 0 to 25 mole % of a different aromatic and/or aliphatic dicarboxylic acid residues having up to 20 carbon atoms; and
(b) a glycol component comprising:
   i) 50 to 100 mole % of 1,4-cyclohexanedimethanol residues; and
   ii) 0 to 50 mole % of ethylene glycol residues; and
   iii) 0 to 25 mole % of a different aromatic and/or aliphatic modifying glycol residues;
having an inherent viscosity of about 0.4 to about 1.1 dL/g as determined in 60/40 (wt/wt) phenol/tetrachloroethane at a concentration of 0.5 g/100 ml at 25° C.

Examples of materials that can be used for the polyester component or polymeric component (A) in the multicomponent blend can include Durastar MN611, MN621, and DS1910HF or Eastar CN015, A150, or CN005 copolyesters, available from Eastman Chemical Company. Examples of materials that can be used for polymeric components (B) or (C) can include PCT, or Eastar MN004, DN004, MN006, MB002, MN210, MN610, MN620, CN015, and 6763, or Ecdel™ Elastomer 9965, 9966 and/or 9967, or Medstar, or Neostar 19772, or Tritan MP100, MP150, MP200 or TX1800, available from Eastman Chemical Company.

The term “polyester”, as used herein, unless otherwise specifically indicated is intended to include “copolyesters” and is understood to mean a synthetic polymer prepared by the reaction of one or more difunctional carboxylic acids and/or multifunctional carboxylic acids with one or more difunctional hydroxyl compounds and/or multifunctional hydroxyl compounds. Typically, the difunctional carboxylic acid can be a dicarboxylic acid and the difunctional hydroxyl compound can be a dihydric alcohol such as, for example, glycols. The term “glycol” as used herein includes, but is not limited to, diols, glycols, and/or multifunctional hydroxyl compounds. The term “residue”, as used herein, means any organic structure incorporated into a polymer through a polycondensation and/or an esterification reaction from the corresponding monomer. The term “repeating unit”, as used herein, means an organic structure having a dicarboxylic acid residue and a diol residue bonded through a carbonyloxy group. Thus, for example, the dicarboxylic acid residues may be derived from a dicarboxylic acid monomer or its associated acid halides, esters, salts, anhydrides, or mixtures thereof. As used herein, therefore, the term dicarboxylic acid is intended to include dicarboxylic acids and any derivative of a dicarboxylic acid, including its associated acid halides, esters, half-esters, salts, half-salts, anhydrides, mixed anhydrides, or mixtures thereof, useful in a reaction process with a diol to make polyester. As used herein, the term “terephthalic acid” is intended to include terephthalic acid itself and residues thereof as well as any derivative of terephthalic acid, including its associated acid halides, esters, half-esters, salts, half-salts, anhydrides, mixed anhydrides, or mixtures thereof or residues thereof useful in a reaction process with a diol to make polyester.

In one embodiment, terephthalic acid may be used as the starting material. In another embodiment, dimethyl terephthalate may be used as the starting material. In another embodiment, mixtures of terephthalic acid and dimethyl terephthalate may be used as the starting material and/or as an intermediate material.

The polyesters used in the present invention typically can be prepared from dicarboxylic acids and diols which react in substantially equal proportions and are incorporated into the polyester polymer as their corresponding residues. The polyesters of the present invention, therefore, can contain substantially equal molar proportions of acid residues (100 mole %) and diol (and/or multifunctional hydroxyl compounds) residues (100 mole %). The mole percentages provided herein, therefore, may be based on the total moles of acid residues, the total moles of diol residues, or the total moles of repeating units. For example, a polyester containing 30 mole % isophthalic acid, based on the total acid residues, means the polyester contains 30 mole % isophthalic acid residues out of a total of 100 mole % acid residues. Thus, there are 30 moles of isophthalic acid residues among every 100 moles of acid residues. In another example, a polyester containing 30 mole % 2,2,4,4-tetramethyl-1,3-cyclobutanediol, based on the total diol residues, means the polyester contains 30 mole % 2,2,4,4-tetramethyl-1,3-cyclobutanediol residues out of a total of 100 mole % diol residues. Thus, there are 30 moles of 2,2,4,4-tetramethyl-1,3-cyclobutanediol residues among every 100 moles of diol residues.

Unless specified otherwise, diacid monomer mole percent and diol mole % with respect to an individual polyester component (contained in a blend) are based on a total of 100 mole % diacid residues and 100 mole % diol residues.

In embodiments with polyesters containing TMCD, the molar ratio of cis/trans 2,2,4,4-tetramethyl-1,3-cyclobutanediol can vary from the pure form of each or mixtures thereof. In certain embodiments, the molar percentages for cis and/or trans 2,2,4,4,-tetramethyl-1,3-cyclobutanediol are greater than 50 mole % cis and less than 50 mole % trans; or greater than 55 mole % cis and less than 45 mole % trans; or 30 to 70 mole % cis and 70 to 30% trans; or 40 to 60 mole % cis and 60 to 40 mole % trans; or 50 to 70 mole % trans and 50 to 30% cis or 50 to 70 mole % cis and 50 to 30% trans; or 50 to 60 mole % cis and 50 to 40% trans; or 50 to 55 mole % cis and 45 to 50% trans; or 60 to 70 mole % cis and 30 to 40 mole % trans; or greater than 70 mole cis and less than 30 mole % trans; wherein the total sum of the mole percentages for cis- and trans-2,2,4,4-tetramethyl-1,3-cyclobutanediol is equal to 100 mole %. The molar ratio of cis/trans 1,4-cyclohexanedimethanol can vary within the range of 50/50 to 0/100, such as between 40/60 to 20/80.

In embodiments for the polymeric component (A) polyester, isophthalic acid or an ester thereof, such as, for example, dimethyl isophthalate, or a mixture of terephthalic acid and an ester thereof, makes up 20 mole % or more, or at least 25 mole % of the dicarboxylic acid component used to form the polyesters useful in the invention. As used herein, the terms “isophthalic acid” and “dimethyl isophthalate” are used interchangeably, unless specifically indicated otherwise.

In certain embodiments for the polymeric component (A) polyester, terephthalic acid or an ester thereof, such as, for example, dimethyl terephthalate, or a mixture of terephthalic acid and an ester thereof, makes up the majority of the dicarboxylic acid component used to form the polyester. In certain embodiments, terephthalic acid residues can make up a portion or all of the dicarboxylic acid component used to form the polyester at a concentration of at least 50 mole %, such as at least 55 mole %, at least 60 mole %, at least 65 mole %, at least 70 mole %, at least 75 mole %, at least 80 mole %, at least 85 mole %, at least 90 mole %, at least 95 mole %, or at least 99 mole %. In certain embodiments, higher amounts of terephthalic acid can be used in order to produce a higher impact strength polyester. In one embodiment, dimethyl terephthalate is part, or all of the dicarboxylic acid component used to make the polyesters useful in the present invention. As used herein, the terms “terephthalic acid” and “dimethyl terephthalate” are used interchangeably, unless specifically indicated otherwise.

In addition to isophthalic acid and terephthalic acid, the dicarboxylic acid component of the copolyester useful in polymeric component (A) can comprise up to 25 mole %, up to 20 mole %, up to 10 mole %, up to 5 mole %, or up to 1 mole % of one or more modifying aromatic dicarboxylic acids. Yet another embodiment contains 0 mole % modifying aromatic dicarboxylic acids. Thus, if present, it is contemplated that the amount of one or more modifying aromatic dicarboxylic acids can range from any of these preceding endpoint values including, for example, from 0.01 to 30 mole %, 0.01 to 20 mole %, from 0.01 to 10 mole %, from 0.01 to 5 mole % and from 0.01 to 1 mole. In one embodiment, modifying aromatic dicarboxylic acids that may be used in the present invention include but are not limited to those having up to 20 carbon atoms, and which can be linear, para-oriented, or symmetrical. Examples of modifying aromatic dicarboxylic acids which may be used in this invention include, but are not limited to, 4,4′-biphenyldicarboxylic acid, 1,4-, 1,5-, 2,6-, 2,7-naphthalenedicarboxylic acid, and trans-4,4′-stilbenedicarboxylic acid, and esters thereof.

The carboxylic acid component of the polyesters useful for polymeric component (A) can be further modified with up to 25 mole %, up to 20 mole %, up to 10 mole %, up to 5 mole %, or up to 1 mole % of one or more aliphatic dicarboxylic acids containing up to 20 carbon atoms, such as, for example, malonic, succinic, glutaric, adipic, pimelic, suberic, azelaic and dodecanedioic dicarboxylic acids. Certain embodiments can also comprise 0.01 or more mole %, such as 0.1 or more mole %, 1 or more mole %, 5 or more mole %, or 10 or more mole % of one or more modifying aliphatic dicarboxylic acids. Yet another embodiment contains 0 mole % modifying aliphatic dicarboxylic acids. Thus, if present, it is contemplated that the amount of one or more modifying aliphatic dicarboxylic acids can range from any of these preceding endpoint values including, for example, from 0.01 to 10 mole % and from 0.1 to 10 mole %. The total mole % of the dicarboxylic acid component is 100 mole %.

Esters of terephthalic acid and the other modifying dicarboxylic acids or their corresponding esters and/or salts may be used instead of the dicarboxylic acids. Suitable examples of dicarboxylic acid esters include, but are not limited to, the dimethyl, diethyl, dipropyl, diisopropyl, dibutyl, and diphenyl esters. In one embodiment, the esters are chosen from at least one of the following: methyl, ethyl, propyl, isopropyl, and phenyl esters.

The 1,4-cyclohexanedimethanol may be cis, trans, or a mixture thereof, for example a cis/trans ratio of 60:40 to 40:60. In another embodiment, the trans-1,4-cyclohexanedimethanol can be present in an amount of 60 to 80 mole %.

In embodiments, the glycol component of the polyesters of polymeric component (A) described above can contain up to 25 mole % of one or more modifying glycols which are not 1,4-cyclohexanedimethanol, ethylene glycol, or 2,2,4,4-tetramethyl-1,3-cyclobutanediol.

Modifying glycols useful in the polyesters can be diols other than isophthalic acid, 1,4-cyclohexanedimethanol, ethylene glycol, or 2,2,4,4-tetramethyl-1,3-cyclobutanediol and may contain 2 to 16 carbon atoms. Examples of suitable modifying glycols include, but are not limited to, 1,2-propanediol, 1,3-propanediol, neopentyl glycol, 1,4-butanediol, 1,5-pentanediol, 1,6-hexanediol, p-xylene glycol, isosorbide or mixtures thereof. In another embodiment, the modifying glycols are 1,3-propanediol and/or 1,4-butanediol. In another embodiment, 1,3-propanediol and 1,4-butanediol are excluded as modifying diols. In another embodiment, 2,2-dimethyl-1,3-propanediol is excluded as a modifying diol.

In embodiments, the polyesters as described herein (for a single component copolyester film or for polymeric component (A) in a multicomponent film) can further comprise from 0 to 10 mole percent, for example, from 0.01 to 5 mole percent, from 0.01 to 1 mole percent, from 0.05 to 5 mole percent, from 0.05 to 1 mole percent, or from 0.1 to 0.7 mole percent, based the total mole percentages of either the diol or diacid residues; respectively, of one or more residues of a branching monomer or agent, also referred to herein as a branching agent, having 3 or more carboxyl substituents, hydroxyl substituents, or a combination thereof. In embodiments, the polyesters described herein (in embodiments for polymeric components (B) and/or (C)) can also include branching agents in an amount from 0 to 10 mole percent, for example, from 0.01 to 5 mole percent, from 0.01 to 1 mole percent, from 0.05 to 5 mole percent, from 0.05 to 1 mole percent, or from 0.1 to 0.7 mole percent, based the total mole percentages of either the diol or diacid residues.

In certain embodiments, the branching monomer or agent may be added prior to and/or during and/or after the polymerization of the polyester. The polyester(s) useful in the invention can thus be linear or branched.

Examples of branching monomers or agents can include, but are not limited to, multifunctional acids or multifunctional alcohols such as trimellitic acid, trimellitic anhydride, pyromellitic dianhydride, trimethylolpropane, glycerol, pentaerythritol, citric acid, tartaric acid, 3-hydroxyglutaric acid and the like. In one embodiment, the branching monomer residues can comprise 0.1 to 0.7 mole percent of one or more residues chosen from at least one of the following: trimellitic anhydride, pyromellitic dianhydride, glycerol, sorbitol, 1,2,6-hexanetriol, pentaerythritol, trimethylolethane, and/or trimesic acid. The branching monomer or agent may be added to the polyester reaction mixture or blended with the polyester in the form of a concentrate as described, for example, in U.S. Pat. Nos. 5,654,347 and 5,696,176, whose disclosure regarding branching monomers is incorporated herein by reference.

Maintaining a glass transition temperature above the conditions experienced by the film in the dental appliance or other application can be important to the dimensional stability of the product. In certain embodiments, the Tg of the copolyester or multicomponent film is at least 10° C. above, or at least above 20° C. above, or at least 30° C. above, or at least 40° C. above, or at least 50° C. above anticipated in-use temperatures, e.g., 35 to 40° C., or about 37° C.

In certain embodiments, the Tg of the copolyester or multicomponent film remains at least 10° C. above, or at least above 20° C. above, or at least 30° C. above, or at least 40° C. above, or at least 50° C. above anticipated in-use temperatures, e.g., 35 to 40° C., or about 37° C., after 24 hours of exposure to humidity above 90% RH or after 24 hours submerged in water at the in-use temperature, e.g., 35 to 40° C., or about 37° C.

In certain embodiments, the Tg of the isophthalic acid containing polyesters useful for the copolyester or polymeric component (A) in the multicomponent film can be from about 50 to 130° C., or 60 to 120° C., or 70 to 110° C. In certain embodiments, the Tg of the polyesters useful for polymeric component (B) and/or (C) can be from about 30 to 130° C., or 50 to 130° C., or 70 to 130° C., or 90 to 130° C., or 100 to 130° C., or 105 to 130° C., or 110 to 130° C., or 50 to 120° C., or 70 to 120° C., or 90 to 120° C., or 100 to 120° C., or 105 to 120° C., or 110 to 120° C., or 50 to 110° C., or 70 to 110° C., or 90 to 110° C., or 100 to 110° C., or 105 to 110° C. The glass transition temperature (Tg) of the polyesters can be determined using a TA DSC 2920 from Thermal Analyst Instrument at a scan rate of 20° C./min on a sample dried in a vacuum oven for 24 hours prior to testing.

In certain embodiments, the Tg of the polymeric components after exposure to high humidity or water-submersion environments are relevant. This will be referred to as the “wet Tg.” The wet Tg of the isophthalic acid containing polyesters useful for the copolyester or polymeric component (A) in the multicomponent film can be from about 30 to 130° C., or 50 to 130° C., or 70 to 130° C., or 90 to 130° C., or 100 to 130° C., or 105 to 130° C., or 110 to 130° C., or 50 to 120° C., or 70 to 120° C., or 90 to 120° C., or 100 to 120° C., or 105 to 120° C., or 110 to 120° C., or 50 to 110° C., or 70 to 110° C., or 90 to 110° C., or 100 to 110° C., or 105 to 110° C. In certain embodiments, the wet Tg of the polyesters useful for polymeric component (B) and/or (C) can be from about 30 to 130° C., or 50 to 120° C., or 70 to 110° C. The wet Tg of the polyesters can be determined using a TA DSC 2920 from Thermal Analyst Instrument at a scan rate of 20° C./min on a sample submerged in water at 40° C. for a minimum of 24 hours prior to testing.

In embodiments, the glass transition temperature (Tg) of the polymer or multicomponent composition that is utilized to make the film can be at least 57° C., or greater than 57° C., or at least 67° C., or greater than 67° C., or at least 77° C., or greater than 77° C., when measured via DSC using a TA DSC 2920 from Thermal Analyst Instrument at a scan rate of 20° C./min on a sample dried in a vacuum oven for 24 hours prior to testing.

In addition, the multicomponent compositions useful in this invention may also contain from 0.01 to 20% by weight or 0.01 to 15% by weight or 0.01 to 10% by weight or 0.01 to 5% by weight of the total weight of the polyester composition of common additives such as colorants, dyes, slip or release agents, friction modifiers, rheology modifiers, processing aids, anti-blocking additives, inorganic fillers, impact modifiers, and/or stabilizers, including but not limited to thermal or hydrolytic stabilizers.

In certain embodiments, where the copolyester or polymeric component (A) in the multicomponent film comprises copolyesters containing isophthalic acid and terephthalic acid residues, the acid component for the polyesters can include but is not limited to at least one of the following combinations of ranges: 1 to 99 mole % isophthalic acid and 1 to 99 mole % terephthalic acid residues; 1 to 75 mole % isophthalic acid and 25 to 99 mole % terephthalic acid residues; 1 to 50 mole % isophthalic acid and 50 to 99 mole % terephthalic acid residues; 5 to less than 50 mole % isophthalic acid and greater than 50 up to 95 mole % terephthalic acid residues; 15 to 50 mole % isophthalic acid and 50 to 85 mole % terephthalic acid residues; 15 to less than 40 mole % isophthalic acid and greater than 60 up to 85 mole % terephthalic acid residues; or 25 to 50 mole % isophthalic acid and 50 to 75 mole % terephthalic acid residues; or 25 to 35 mole % isophthalic acid and 65 to 75 mole % terephthalic acid residues; or 26 to 48 mole % isophthalic acid and 65 to 75 mole % terephthalic acid residues; or more than 20 to less than 40 mole % isophthalic acid and greater than 60 up to 80 mole % terephthalic acid residues.

In other embodiments, where the copolyester or polymeric component (A) in the multicomponent film comprises copolyesters containing CHDM and EG residues, the glycol component for the polyesters can include but is not limited to at least one of the following combinations of ranges: 1 to 99 mole % 1,4-cyclohexanedimethanol and 1 to 99 mole % ethylene glycol; 80 to 99 mole % 1,4-cyclohexanedimethanol and 1 to 80 mole % ethylene glycol; 60 to 99 mole % 1,4-cyclohexanedimethanol and 1 to 40 mole % ethylene glycol; 50 to 99 mole % 1,4-cyclohexanedimethanol and 1 to 50 mole % ethylene glycol; 40 to 99 mole % 1,4-cyclohexanedimethanol and 1 to 60 mole % ethylene glycol; 75 to 99 mole % 1,4-cyclohexanedimethanol and 1 to 25 mole % ethylene glycol; or 80 to 99 mole % 1,4-cyclohexanedimethanol and 1 to 20 mole % ethylene glycol.

In other embodiments, where the copolyester or polymeric component (A) in the multicomponent film comprises copolyesters containing TMCD in addition to other glycol residues, the glycol component for the polyesters can include but is not limited to at least one of the following combinations of ranges: 1 to 99 mole % 2,2,4,4-tetramethyl-1,3-cyclobutanediol and 1 to 99 mole % other glycols; 1 to 75 mole % 2,2,4,4-tetramethyl-1,3-cyclobutanediol and 25 to 99 mole % other glycols; 1 to 50 mole % 2,2,4,4-tetramethyl-1,3-cyclobutanediol and 50 to 99 mole % other glycols; 1 to 40 mole % 2,2,4,4-tetramethyl-1,3-cyclobutanediol and 60 to 99 mole % other glycols; 1 to 35 mole % 2,2,4,4-tetramethyl-1,3-cyclobutanediol and 65 to 99 mole % other glycols; 1 to 30 mole % 2,2,4,4-tetramethyl-1,3-cyclobutanediol and 70 to 99 mole % other glycols; 1 to 25 mole % 2,2,4,4-tetramethyl-1,3-cyclobutanediol and 75 to 99 mole % other glycols; 1 to 20 mole % 2,2,4,4-tetramethyl-1,3-cyclobutanediol and 80 to 99 mole % other glycols; or 1 to 10 mole % 2,2,4,4-tetramethyl-1,3-cyclobutanediol and 90 to 99 mole % other glycols.

In other embodiments, where the copolyester or polymeric component (A) in the multicomponent film comprises copolyesters containing isosorbide in addition to other glycol residues, the glycol component for the polyesters can include but is not limited to at least one of the following combinations of ranges: 1 to 99 mole % isosorbide and 1 to 99 mole % other glycols; 1 to 75 mole % isosorbide and 25 to 99 mole % other glycols; 1 to 50 mole % isosorbide and 50 to 99 mole % other glycols; 1 to 40 mole % isosorbide and 60 to 99 mole % other glycols; 1 to 35 mole % isosorbide and 65 to 99 mole % other glycols; 1 to 30 mole % isosorbide and 70 to 99 mole % other glycols; 1 to 25 mole % isosorbide and 75 to 99 mole % other glycols; 1 to 20 mole % isosorbide and 80 to 99 mole % other glycols; or 1 to 10 mole % isosorbide and 90 to 99 mole % other glycols.

In other embodiments, where the copolyester or polymeric component (A) in the multicomponent film comprises copolyesters containing neopentyl glycol in addition to other glycol residues, the glycol component for the polyesters can include but is not limited to at least one of the following combinations of ranges: 1 to 99 mole % neopentyl glycol and 1 to 99 mole % other glycols; 1 to 75 mole % neopentyl glycol and 25 to 99 mole % other glycols; 1 to 50 mole % neopentyl glycol and 50 to 99 mole % other glycols; 1 to 40 mole % neopentyl glycol and 60 to 99 mole % other glycols; 1 to 35 mole % neopentyl glycol and 65 to 99 mole % other glycols; 1 to 30 mole % neopentyl glycol and 70 to 99 mole % other glycols; 1 to 25 mole % neopentyl glycol and 75 to 99 mole % other glycols; 1 to 20 mole % neopentyl glycol and 80 to 99 mole % other glycols; or 1 to 10 mole % neopentyl glycol and 90 to 99 mole % other glycols.

In other embodiments, where the copolyester or polymeric component (A) in the multicomponent film comprises copolyesters containing methyl propane diol (MP Diol), e.g., 2-methyl-1,3-propanediol, in addition to other glycol residues, the glycol component for the polyesters can include but is not limited to at least one of the following combinations of ranges: 1 to 99 mole % MP Diol and 1 to 99 mole % other glycols; 1 to 75 mole % MP Diol and 25 to 99 mole % other glycols; 1 to 50 mole % MP Diol and 50 to 99 mole % other glycols; 1 to 40 mole % MP Diol and 60 to 99 mole % other glycols; 1 to 35 mole % MP Diol and 65 to 99 mole % other glycols; 1 to 30 mole % MP Diol and 70 to 99 mole % other glycols; 1 to 25 mole % MP Diol and 75 to 99 mole % other glycols; 1 to 20 mole % MP Diol and 80 to 99 mole % other glycols; or 1 to 10 mole % MP Diol and 90 to 99 mole % other glycols.

In embodiments, the copolyester or multicomponent film has at least one of the following properties chosen from: a Tg of from about 70 to about 120° C. as measured by a TA 2100 Thermal Analyst Instrument at a scan rate of 20° C./min, a flexural modulus at 23° C. of greater than about 1800 MPa (290,000 psi), or greater than 1900 MPa, or greater than 2000 MPa, as defined by ASTM D790, and an average tear propagation resistance greater than 30 N/mm, or 35 N/mm, or 40 N/mm in both the machine and transverse direction when measured according to ASTM D 1938. In one embodiment, the b* color value for the film is 2 or less, or lower than 2, as determined by the L*a*b* color system measured following ASTM E 1348. In one embodiment, the haze value for the film is 30% or less, or 25% or less, or 20% or less, or lower than 20%, or 15% or less, or 10% or less, or 5% or less, as determined by the L*a*b* color system measured on a 0.75 mm film following ASTM D 1003.

In embodiments, the polyesters described herein for embodiments for the copolyester or polymeric component (A) in the multicomponent film may exhibit at least one of the following inherent viscosities as determined in 60/40 (wt/wt) phenol/tetrachloroethane at a concentration of 0.5 g/100 ml at 25° C.: 0.40 to 1.2 dL/g; 0.40 to 1.1 dL/g; 0.40 to 1 dL/g; 0.40 to less than 1 dL/g; 0.40 to 0.98 dL/g; 0.40 to 0.95 dL/g; 0.40 to 0.90 dL/g; 0.40 to 0.85 dL/g; 0.40 to 0.80 dL/g; 0.40 to 0.75 dL/g; 0.40 to less than 0.75 dL/g; 0.40 to 0.72 dL/g; 0.40 to 0.70 dL/g; 0.10 to less than 0.70 dL/g; 0.10 to 0.68 dL/g; 0.10 to less than 0.68 dL/g; 0.40 to 0.65 dL/g; greater than 0.50 to 1.1 dL/g; greater than 0.50 to 1 dL/g; greater than 0.50 to less than 1 dL/g; greater than 0.50 to 0.98 dL/g; greater than 0.50 to 0.95 dL/g; greater than 0.50 to 0.90 dL/g; greater than 0.50 to 0.85 dL/g; greater than 0.60 to 0.80 dL/g; greater than 0.60 to 0.75 dL/g; greater than 0.60 to less than 1.1 dL/g; greater than 0.60 to 1.1 dL/g; greater than 0.60 to less than 0.9 dL/g; greater than 0.60 to 0.8 dL/g; greater than 0.60 to less than 0.8 dL/g; greater than 0.65 to 1.1 dL/g; greater than 0.65 to less than 0.9 dL/g; greater than 0.65 to 0.8 dL/g; 0.70 to 1.1 dL/g; 0.75 to 1.1 dL/g; 0.80 to 1.1 dL/g, or 0.85 to 1.1 dL/g.

For certain embodiments, the polyesters described herein in embodiments for polymeric component (B) or (C) comprising 1,4-cyclohexane dicarboxylate may exhibit at least one of the following inherent viscosities as determined in 60/40 (wt/wt) phenol/tetrachloroethane at a concentration of 0.5 g/100 ml at 25° C.: 0.40 to 1.2 dL/g; 0.40 to 1.1 dL/g; 0.40 to 1 dL/g; 0.40 to less than 1 dL/g; 0.40 to 0.98 dL/g; 0.40 to 0.95 dL/g; 0.40 to 0.90 dL/g; 0.40 to 0.85 dL/g; 0.40 to 0.80 dL/g; 0.40 to 0.75 dL/g; 0.40 to less than 0.75 dL/g; 0.40 to 0.72 dL/g; 0.40 to 0.70 dL/g; 0.10 to less than 0.70 dL/g; 0.10 to 0.68 dL/g; 0.10 to less than 0.68 dL/g; 0.40 to 0.65 dL/g; greater than 0.50 to 1.1 dL/g; greater than 0.50 to 1 dL/g; greater than 0.50 to less than 1 dL/g; greater than 0.50 to 0.98 dL/g; greater than 0.50 to 0.95 dL/g; greater than 0.50 to 0.90 dL/g; greater than 0.50 to 0.85 dL/g; greater than 0.60 to 0.80 dL/g; greater than 0.60 to 0.75 dL/g; greater than 0.60 to less than 1.1 dL/g; greater than 0.60 to 1.1 dL/g; greater than 0.60 to less than 0.9 dL/g; greater than 0.60 to 0.8 dL/g; greater than 0.60 to less than 0.8 dL/g; greater than 0.65 to 1.1 dL/g; greater than 0.65 to less than 0.9 dL/g; greater than 0.65 to 0.8 dL/g; 0.70 to 1.1 dL/g; 0.75 to 1.1 dL/g; 0.80 to 1.1 dL/g, or 0.85 to 1.1 dL/g.

In various embodiments, the relative amounts of components (A), (B) and (C) can be chosen from: 25 to 99 wt % component (A) and 1 to 75 wt % component (B) and/or (C), or greater than 25 to 99 wt % component (A) and 1 to less than 75 wt % component (B) and/or (C), or 30 to 99 wt % component (A) and 1 to 70 wt % component (B) and/or (C), or 35 to 99 wt % component (A) and 1 to 65 wt % component (B) and/or (C), 40 to 99 wt % component (A) and 1 to 60 wt % component (B) and/or (C), or greater than 40 to 99 wt % component (A) and 1 to less than 60 wt % component (B) and/or (C), or 45 to 99 wt % component (A) and 1 to 55 wt % component (B) and/or (C), or 50 to 99 wt % component (A) and 1 to 50 wt % component (B) and/or (C), or greater than 50 to 99 wt % component (A) and 1 to less than 50 wt % component (B) and/or (C), or 55 to 99 wt % component (A) and 1 to 45 wt % component (B) and/or (C), or 60 to 99 wt % component (A) and 1 to 40 wt % component (B) and/or (C), or 65 to 99 wt % component (A) and 1 to 35 wt % component (B) and/or (C), or 70 to 99 wt % component (A) and 1 to 30 wt % component (B) and/or (C), or 75 to 99 wt % component (A) and 1 to 25 wt % component (B) and/or (C), or 80 to 99 wt % component (A) and 1 to 20 wt % component (B) and/or (C), or 25 to 95 wt % component (A) and 5 to 75 wt % component (B) and/or (C), or 30 to 95 wt % component (A) and 5 to 70 wt % component (B) and/or (C), or 35 to 95 wt % component (A) and 5 to 65 wt % component (B) and/or (C), or 40 to 95 wt % component (A) and 5 to 60 wt % component (B) and/or (C), or 45 to 95 wt % component (A) and 5 to 55 wt % component (B) and/or (C), or 50 to 95 wt % component (A) and 5 to 50 wt % component (B) and/or (C), or 55 to 95 wt % component (A) and 5 to 45 wt % component (B) and/or (C), or 60 to 95 wt % component (A) and 5 to 40 wt % component (B) and/or (C), or 65 to 95 wt % component (A) and 5 to 35 wt % component (B) and/or (C), or 70 to 95 wt % component (A) and 5 to 30 wt % component (B) and/or (C), or 75 to 95 wt % component (A) and 5 to 25 wt % component (B) and/or (C), or 80 to 95 wt % component (A) and 5 to 20 wt % component (B) and/or (C), or 25 to 90 wt % component (A) and 10 to 75 wt % component (B) and/or (C), or 30 to 90 wt % component (A) and 10 to 70 wt % component (B) and/or (C), or 35 to 90 wt % component (A) and 10 to 65 wt % component (B) and/or (C), or 40 to 90 wt % component (A) and 10 to 60 wt % component (B) and/or (C), or 45 to 90 wt % component (A) and 10 to 55 wt % component (B) and/or (C), or 50 to 90 wt % component (A) and 10 to 50 wt % component (B) and/or (C), or 55 to 90 wt % component (A) and 10 to 45 wt % component (B) and/or (C), or 60 to 90 wt % component (A) and 10 to 40 wt % component (B) and/or (C), or 65 to 90 wt % component (A) and 10 to 35 wt % component (B) and/or (C), or 70 to 90 wt % component (A) and 10 to 30 wt % component (B) and/or (C), or 75 to 90 wt % component (A) and 10 to 25 wt % component (B) and/or (C), or 80 to 90 wt % component (A) and 10 to 20 wt % component (B) and/or (C).

The relative amounts of each component containing polyesters according to various embodiments (in the multicomponent composition) is described below. For purposes of this application: “CHDM and TMCD polyester” refers to any of the embodiments described herein for polyesters containing both CHDM and TMCD residues in the diol component of the polyester; “CHDM and EG polyester” refers to any of the embodiments described herein for polyesters containing both CHDM and EG residues in the diol component of the polyester; “isosorbide polyester” refers to any of the embodiments described herein for polyesters containing isosorbide residues in the diol component of the polyester; “polyesterether” refers to any of the embodiments described herein for polyesters containing a polyesterether in the diol component of the polyester; “isophthalic acid copolyester” refers to any of the embodiments described herein for polyesters containing isophthalic acid residues in the diacid component of the polyester; and “terephthalic acid copolyester” refers to any of the embodiments described herein for polyesters containing terephthalic acid residues in the diacid component of the polyester; and “cyclohexanedicarboxylic acid (CHDA) polyester” refers to any of the embodiments described herein for polyesters containing CHDA residues in the diacid component of the polyester.

In embodiments, the multicomponent composition comprises polymeric component (A) containing an isophthalic acid polyester and component (B) containing a CHDM and EG polyester or a CHDM and TMCD copolyester in one or the following amounts: 40 to 99 wt % component (A) and 1 to 60 wt % component (B), or greater than 40 to 99 wt % component (A) and 1 to less than 60 wt % component (B), or 45 to 99 wt % component (A) and 1 to 55 wt % component (B), or 50 to 99 wt % component (A) and 1 to 50 wt % component (B), or greater than 50 to 99 wt % component (A) and 1 to less than 50 wt % component (B), or 55 to 99 wt % component (A) and 1 to 45 wt % component (B), or 60 to 99 wt % component (A) and 1 to 40 wt % component (B), or 65 to 99 wt % component (A) and 1 to 35 wt % component (B), or 70 to 99 wt % component (A) and 1 to 30 wt % component (B), or 75 to 99 wt % component (A) and 1 to 25 wt % component (B), or 80 to 99 wt % component (A) and 1 to 20 wt % component (B), or 55 to 95 wt % component (A) and 5 to 45 wt % component (B), or 60 to 95 wt % component (A) and 5 to 40 wt % component (B), or 65 to 95 wt % component (A) and 5 to 35 wt % component (B), or 70 to 95 wt % component (A) and 5 to 30 wt % component (B), or 75 to 95 wt % component (A) and 5 to 25 wt % component (B), or 80 to 95 wt % component (A) and 5 to 20 wt % component (B), or 55 to 90 wt % component (A) and 10 to 45 wt % component (B), or 60 to 90 wt % component (A) and 10 to 40 wt % component (B), or 65 to 90 wt % component (A) and 10 to 35 wt % component (B), or 70 to 90 wt % component (A) and 10 to 30 wt % component (B), or 75 to 90 wt % component (A) and 10 to 25 wt % component (B), or 80 to 90 wt % component (A) and 10 to 20 wt % component (B).

In embodiments, the multicomponent composition comprises polymeric component (A) containing an isophthalic acid polyester and component (B) containing an isosorbide copolyester in one or the following amounts: 40 to 99 wt % component (A) and 1 to 60 wt % component (B), or greater than 40 to 99 wt % component (A) and 1 to less than 60 wt % component (B), or 45 to 99 wt % component (A) and 1 to 55 wt % component (B), or 50 to 99 wt % component (A) and 1 to 50 wt % component (B), or greater than 50 to 99 wt % component (A) and 1 to less than 50 wt % component (B), or 55 to 99 wt % component (A) and 1 to 45 wt % component (B), or 60 to 99 wt % component (A) and 1 to 40 wt % component (B), or 65 to 99 wt % component (A) and 1 to 35 wt % component (B), or 70 to 99 wt % component (A) and 1 to 30 wt % component (B), or 75 to 99 wt % component (A) and 1 to 25 wt % component (B), or 80 to 99 wt % component (A) and 1 to 20 wt % component (B), or 55 to 95 wt % component (A) and 5 to 45 wt % component (B), or 60 to 95 wt % component (A) and 5 to 40 wt % component (B), or 65 to 95 wt % component (A) and 5 to 35 wt % component (B), or 70 to 95 wt % component (A) and 5 to 30 wt % component (B), or 75 to 95 wt % component (A) and 5 to 25 wt % component (B), or 80 to 95 wt % component (A) and 5 to 20 wt % component (B), or 55 to 90 wt % component (A) and 10 to 45 wt % component (B), or 60 to 90 wt % component (A) and 10 to 40 wt % component (B), or 65 to 90 wt % component (A) and 10 to 35 wt % component (B), or 70 to 90 wt % component (A) and 10 to 30 wt % component (B), or 75 to 90 wt % component (A) and 10 to 25 wt % component (B), or 80 to 90 wt % component (A) and 10 to 20 wt % component (B).

In embodiments, the multicomponent composition comprises polymeric component (A) containing an isophthalic acid polyester and component (B) containing a CHDA polyester in one or the following amounts: 40 to 99 wt % component (A) and 1 to 60 wt % component (B), or greater than 40 to 99 wt % component (A) and 1 to less than 60 wt % component (B), or 45 to 99 wt % component (A) and 1 to 55 wt % component (B), or 50 to 99 wt % component (A) and 1 to 50 wt % component (B), or greater than 50 to 99 wt % component (A) and 1 to less than 50 wt % component (B), or 55 to 99 wt % component (A) and 1 to 45 wt % component (B), or 60 to 99 wt % component (A) and 1 to 40 wt % component (B), or 65 to 99 wt % component (A) and 1 to 35 wt % component (B), or 70 to 99 wt % component (A) and 1 to 30 wt % component (B), or 75 to 99 wt % component (A) and 1 to 25 wt % component (B), or 80 to 99 wt % component (A) and 1 to 20 wt % component (B), or 55 to 95 wt % component (A) and 5 to 45 wt % component (B), or 60 to 95 wt % component (A) and 5 to 40 wt % component (B), or 65 to 95 wt % component (A) and 5 to 35 wt % component (B), or 70 to 95 wt % component (A) and 5 to 30 wt % component (B), or 75 to 95 wt % component (A) and 5 to 25 wt % component (B), or 80 to 95 wt % component (A) and 5 to 20 wt % component (B), or 55 to 90 wt % component (A) and 10 to 45 wt % component (B), or 60 to 90 wt % component (A) and 10 to 40 wt % component (B), or 65 to 90 wt % component (A) and 10 to 35 wt % component (B), or 70 to 90 wt % component (A) and 10 to 30 wt % component (B), or 75 to 90 wt % component (A) and 10 to 25 wt % component (B), or 80 to 90 wt % component (A) and 10 to 20 wt % component (B).

In embodiments, the multicomponent composition comprises polymeric component (A) containing an isophthalic acid polyester and polymeric component (B) containing a copolyester comprising: a dicarboxylic acid component that comprises at least 50 mole % of a diacid residue chosen from terephthalic acid, cyclohexanedicarboxylic acid (CHDA), or furandicarboxylic acid (FDCA), based on the mole % of the dicarboxylic acid component being 100 mole %; and a glycol component that comprises at least 40 mole %, or at least 50 mole %, or at least 60 mole % of a diol residue of CHDM. In embodiments, polymeric components (A) and (B) are present in one or the following amounts: 40 to 99 wt % component (A) and 1 to 60 wt % component (B), or greater than 40 to 99 wt % component (A) and 1 to less than 60 wt % component (B), or 45 to 99 wt % component (A) and 1 to 55 wt % component (B), or 50 to 99 wt % component (A) and 1 to 50 wt % component (B), or greater than 50 to 99 wt % component (A) and 1 to less than 50 wt % component (B), or 55 to 99 wt % component (A) and 1 to 45 wt % component (B), or 60 to 99 wt % component (A) and 1 to 40 wt % component (B), or 65 to 99 wt % component (A) and 1 to 35 wt % component (B), or 70 to 99 wt % component (A) and 1 to 30 wt % component (B), or 75 to 99 wt % component (A) and 1 to 25 wt % component (B), or 80 to 99 wt % component (A) and 1 to 20 wt % component (B), or 55 to 95 wt % component (A) and 5 to 45 wt % component (B), or 60 to 95 wt % component (A) and 5 to 40 wt % component (B), or 65 to 95 wt % component (A) and 5 to 35 wt % component (B), or 70 to 95 wt % component (A) and 5 to 30 wt % component (B), or 75 to 95 wt % component (A) and 5 to 25 wt % component (B), or 80 to 95 wt % component (A) and 5 to 20 wt % component (B), or 55 to 90 wt % component (A) and 10 to 45 wt % component (B), or 60 to 90 wt % component (A) and 10 to 40 wt % component (B), or 65 to 90 wt % component (A) and 10 to 35 wt % component (B), or 70 to 90 wt % component (A) and 10 to 30 wt % component (B), or 75 to 90 wt % component (A) and 10 to 25 wt % component (B), or 80 to 90 wt % component (A) and 10 to 20 wt % component (B).

In certain embodiments, for the multicomponent composition described above, polymeric component (A) has an acid component having 20 to 60 mole % isophthalic acid residues and a glycol component having at least 50 mole %, or at least 60 mole %, or at least 70 mole % CHDM residues, and component (B) has a composition as follows: (1) acid component having at least 50 mole % TPA residues and glycol component having at least 45 mole %, or at least 50 mole %, or at least 60 mole % CHDM residues; or (2) acid component having at least 50 mole % TPA residues and glycol component having at least 45 mole %, or at least 50 mole %, or at least 60 mole % CHDM residues and 5 to 40 mole %, or 5 to 30 mole % TMCD residues; or (3) acid component having at least 50 mole % TPA residues and glycol component having at least 45 mole %, or at least 50 mole %, or at least 60 mole % CHDM residues and 5 to 30 mole %, or 5 to 20 mole % isosorbide residues; or (4) acid component having at least 50 mole % TPA residues and glycol component having at least 45 mole %, or at least 50 mole %, or at least 60 mole % CHDM residues and 5 to 45 mole %, or 5 to 40 mole %, or 5 to 30 mole % EG residues; or (5) acid component having at least 50 mole % TPA residues and glycol component having at least 45 mole %, or at least 50 mole %, or at least 60 mole % EG residues and 5 to 45 mole %, or 5 to 40 mole %, or 5 to 30 mole % CHDM residues; or (6) acid component having at least 50 mole % TPA residues and glycol component having at least 20 mole %, or at least 40 mole %, or at least 50 mole % NPG residues; or (7) acid component having at least 50 mole % TPA residues and glycol component having at least 20 mole %, or at least 40 mole %, or at least 50 mole % MP Diol residues; or (8) acid component having at least 50 mole % CHDA residues and glycol component having at least 45 mole %, or at least 50 mole % CHDM residues; or (9) acid component having at least 50 mole % CHDA residues and glycol component having at least 45 mole %, or at least 50 mole % CHDM residues and 5 to 40 mole %, or 5 to 30 mole % TMCD residues; or (10) acid component having at least 50 mole % CHDA residues and glycol component having at least 45 mole %, or at least 50 mole %, or at least 60 mole % CHDM residues and 5 to 30 mole %, or 5 to 20 mole % isosorbide residues; or (11) acid component having at least 50 mole %, or at least 60 mole %, or at least 70 mole % CHDA residues and glycol component having at least 45 mole %, or at least 50 mole %, or at least 60 mole % CHDM residues and 5 to 30 mole %, or 5 to 20 mole % polyalkylene ether glycol (e.g., polytetramethylene ether glycol) residues; or (12) acid component having at least 50 mole % CHDA residues and glycol component having at least 45 mole %, or at least 50 mole %, or at least 60 mole % CHDM residues and 5 to 40 mole %, or 5 to 30 mole % EG residues; or (13) acid component having at least 50 mole % CHDA residues and glycol component having at least 20 mole %, or at least 40 mole %, or at least 50 mole % NPG residues; or (14) acid component having at least 50 mole % CHDA residues and glycol component having at least 20 mole %, or at least 40 mole %, or at least 50 mole % MP Diol residues; or (15) acid component having at least 50 mole % FDCA residues and glycol component having at least 45 mole %, or at least 50 mole % CHDM residues; or (16) acid component having at least 50 mole % FDCA residues and glycol component having at least 45 mole %, or at least 50 mole % CHDM residues and 5 to 40 mole %, or 5 to 30 mole % TMCD residues; or (17) acid component having at least 50 mole % FDCA residues and glycol component having at least 45 mole %, or at least 50 mole %, or at least 60 mole % CHDM residues and 5 to 30 mole %, or 5 to 20 mole % isosorbide residues; or (18) acid component having at least 50 mole % FDCA residues and glycol component having at least 45 mole %, or at least 50 mole %, or at least 60 mole % CHDM residues and 5 to 40 mole %, or 5 to 30 mole % EG residues; or (19) acid component having at least 50 mole % FDCA residues and glycol component having at least 20 mole %, or at least 40 mole %, or at least 50 mole % NPG residues; or (20) acid component having at least 50 mole % FDCA residues and glycol component having at least 20 mole %, or at least 40 mole %, or at least 50 mole % MP Diol residues.

In certain embodiments, for the multicomponent composition described above, polymeric component (A) has an acid component having 20 to 60 mole % isophthalic acid residues and a glycol component having at least 50 mole %, or at least 60 mole %, or at least 70 mole % CHDM residues, and component (B) has a composition as follows: (1) acid component having at least 50 mole % TPA residues and glycol component having at least 45 mole %, or at least 50 mole %, or at least 60 mole % CHDM residues and 5 to 30 mole %, or 5 to 20 mole % isosorbide residues and 5 to 40 mole %, or 5 to 30 mole %, or 5 to 20 mole % EG residues; or (2) acid component having at least 50 mole % CHDA residues and glycol component having at least 45 mole %, or at least 50 mole %, or at least 60 mole % CHDM residues and 5 to 30 mole %, or 5 to 20 mole % isosorbide residues and 5 to 40 mole %, or 5 to 30 mole %, or 5 to 20 mole % EG residues; or (3) acid component having at least 50 mole % FDCA residues and glycol component having at least 45 mole %, or at least 50 mole %, or at least 60 mole % CHDM residues and 5 to 30 mole %, or 5 to 20 mole % isosorbide residues and 5 to 40 mole %, or 5 to 30 mole %, or 5 to 20 mole % EG residues.

In certain embodiments, the polymeric component (A) as described herein is a minority component of the multicomponent composition. In such embodiments, the majority component can be polymeric component (B) as described in any of the embodiments herein.

In embodiments for any of the multicomponent compositions, the multicomponent composition containing a blend of polymer component (A) with polymer component (B) and/or (C) comprises diacid residues comprising from about 5 to about 35, or 5 to 30, or 5 to 25, or 10 to 35, or 10 to 30, or 10 to 25, or 15 to 35, or 15 to 30, or 15 to 25, or 20 to 35, or 20 to 30, or 20 to 25, or 25 to 35, or 25 to 30, or 30 to 35 net mole percent of IPA residues, wherein the blend comprises a total of 100 mole percent diacid residues and a total of 100 mole percent diol residues.

The term “net mole percent” for a monomer residue in a polyester blend means the total mole % of that monomer for the diacid or diol residues, respectively, contained in the total blend. For example, the net mole percent of a diacid monomer residue with respect to a polyester blend means the total amount of that diacid monomer (in mole percent) for all diacid residues (of all individual polymer components) contained in the blend. Thus, if polyester A contains 70 mole % TPA residues and 30 mole % IPA residues, based on 100 mole % diacid residues for polyester A; polyester B contains 95 mole % TPA resides and 5 mole % IPA residues, based on 100 mole % diacid residues for polyester B; and the blend contains 75 wt % polyester A and 25 wt % polyester B; then the blend has a net mole % of IPA residues of about 23.8 mole %, based on the total diacid residues for the blend.

In certain embodiments, the single or multicomponent composition forms or is contained in one or more layers in a multiple layer structure film. In embodiments, the multiple layer structure film is a three-layer structure having a core layer and two outer layers, one on each side of the core layer. In embodiments, the core layer contains the multicomponent composition and the outer layers are made from other polymeric compositions. In embodiments, at least one of the outer layers contains the multicomponent composition and the core layer is made from another polymeric composition.

In embodiments, a multilayer sheet (or film) comprising at least two layers is provided, the at least two layers comprising a first layer and a second layer, wherein the first layer comprises or consists of the IPA containing polyester and/or the multicomponent composition as described herein and the second layer comprises a polyester different from the polyester/composition of the first layer. In embodiments, the second layer comprises any of the polyesters described herein as being useful for components A, B or C of the multicomponent composition. In one embodiment, the first layer comprises any of the multicomponent compositions described herein and the second layer comprises a TMCD containing polyester.

Examples of suitable second layer polyester materials, depending on the application, can include Eastman Tritan™ MP100, TX1000, TX1500, TX2000, TX1800, MX710, MX711, MX810, MX900 and MX730 copolyesters, available from Eastman Chemical Company.

In one embodiment, the first layer comprises any of the multicomponent compositions described herein and the second layer comprises a CHDA containing polyester and/or a polyester elastomer (e.g., polyesterether elastomer. Examples of a suitable polyester material for such a second layer, depending on the application, can include Neostar™ polyester 19972, available from Eastman Chemical Company. In certain embodiments, examples of a suitable polyester elastomer, e.g., polyesterether elastomer, for such a second layer, depending on the application, can include Ecdel™ Elastomer 9966 (and/or 9967) and/or Eastar™ Copolyester 6763, available from Eastman Chemical Company.

In other embodiments, the first layer comprises any of the multicomponent compositions described herein and the second layer comprises an elastomeric material. In embodiments, the elastomeric material can be chosen from a styrenic block copolymer (SBC), a silicone rubber, an elastomeric alloy, a thermoplastic elastomer (TPE), a thermoplastic vulcanizate (TPV) elastomer, a polyurethane elastomer, a block copolymer elastomer, a polyolefin blend elastomer, a thermoplastic polyester elastomer (e.g., a copolyester elastomer or a polyesterether elastomer), a thermoplastic polyamide elastomer, or combinations thereof (e.g., a blend of at least two of the listed elastomeric materials). In certain embodiments, the second layer can be a polyester elastomer (e.g., polyesterether elastomer) and/or a polyurethane elastomer.

In embodiments, the second layer can comprise a polyesterether or copolyester ether (COPE), e.g., (PCCE) commercially available, for example, from Eastman Chemical Company. The term “polyesters” as used herein with respect to the second layer, is intended to include copolyesterethers. The copolyesterethers can be derived from a dicarboxylic acid component comprising and/or consisting essentially of 1,4-cyclohexanedicarboxylic acid or an ester forming derivative thereof such as dimethyl-1,4-cyclohexanedicarboxylate. This acid and ester are both sometimes referred to herein as DMCD. The diol component can consist essentially of 1,4-cyclohexanedimethanol (CHDM) and polytetramethylene ether glycol (PTMG). The copolyesterethers further can comprise branching agents, for example, from about 0.1 to about 1.5 mole %, based on the acid or glycol component, of a polyfunctional branching agent having at least 3 carboxyl or hydroxyl groups.

In embodiments, the dibasic acid component of the copolyesterether comprises residues of 1,4-cyclohexanedicarboxylic acid or dimethyl-1,4-cyclohexanedicarboxylate having a trans isomer content of at least 65%, or at least 70% or at least 80% or at least 85%. In an embodiment, the dibasic acid component of the copolyesterether can consist essentially of DMCD and can have a trans isomer content of at least 70%, or at least 80% or at least 85%.

In embodiments, the polyesterether included in the second layer can comprise residues of 1,4-cyclohexanedicarboxylic acid or an ester thereof in the amount of from 70-100 weight % or from 80 to 100 weight % or from 90 to 100 weight % or from 95 to 100 weight % or from 98 to 100 weight %, based on a total of 100 weight % acid residues and a total of 100 weight % diol residues. The polyesterether can comprise residues of 1,4-cyclohexanedimethanol and polytetramethylene ether glycol.

In certain embodiments, the polyesterether can comprise residues of from 1 to 50 mole %, or 5 to 50 mole %, or 10 to 50 mole %, or 15 to 50 mole %, or 20 to 50 mole % or 25 to 50 mole %, or 30 to 50 mole %, or 35 to 50 mole %, or 40 to 50 mole %, or 45 to 50 mole %, or 1 to 45 mole %, or 5 to 45 mole %, or 10 to 45 mole %, or 15 to 45 mole %, or 20 to 45 mole % or 25 to 45 mole %, or 30 to 45 mole %, or 35 to 45 mole %, or 40 to 45 mole %, or 1 to 40 mole %, or 5 to 40 mole %, or 10 to 40 mole %, or 15 to 40 mole %, or 20 to 40 mole % or 25 to 40 mole %, or 30 to 40 mole %, or 35 to 40 mole %, or 1 to 35 mole %, or 5 to 35 mole %, or 10 to 35 mole %, or 15 to 35 mole %, or 20 to 35 mole % or 25 to 35 mole %, or 30 to 35 mole %, or 1 to 30 mole %, or 5 to 30 mole %, or 10 to 30 mole %, or 15 to 30 mole %, or 20 to 30 mole % or 25 to 30 mole %, or 1 to 25 mole %, or 5 to 25 mole %, or 10 to 25 mole %, or 15 to 25 mole %, or 20 to 25 mole %, or 1 to 20 mole %, or 5 to 20 mole %, or 10 to 20 mole %, or 15 to 20 mole %, or 1 to 15 mole %, or 5 to 15 mole %, or 10 to 15 mole %, or 1 to 10 mole %, or 5 to 10 mole %, or 1 to 5 mole %, of polytetramethylene ether glycol residues.

In certain embodiments, the polyesterether can comprise residues of from 1 mole % to 20 mole %, or 1 mole % to 15 mole %, or 1 mole % to 12 mole %, or 1 mole % to 10 mole %, or 3 mole % to 12 mole %, or from 5 mole % to 10 weight %, or from 7 to 10 mole %, of polytetramethylene ether glycol residues.

In one embodiment, the polyester portion of the polyesterether comprises residues of at least one glycol as described for the polyesters useful in the invention. In certain embodiments, the polyester portion of the polyesterether comprises residues of at least one glycol selected from ethylene glycol, diethylene glycol, triethylene glycol, isosorbide, propane-1,3-diol, butane-1,4-diol, 2,2-dimethylpropane-1,3-diol (neopentyl glycol), 2,2,4,4,-tetramethyl-1,3-cyclobutanediol, pentane-1,5-diol, hexane-1,6-diol, 1,4-cyclohexanedimethanol, 3-methyl-pentanediol-(2,4), 2-methylpentanediol-(1,4), 2,2,4-tri-methylpentane-diol-(1,3), 2-ethylhexanediol-(1,3), 2,2-diethylpropane-diol-(1,3), hexanediol-(1,3), 1,4-di-(hydroxyethoxy)-benzene, 2,2-bis-(4-hydroxycyclohexyl)-propane, 2,4-dihydroxy-1,1,3,3-tetramethyl-cyclobutane, 2,2-bis-(3-hydroxyethoxyphenyl)-propane, 2,2-bis-(4-hydroxypropoxyphenyl)-propane, and mixtures thereof. In embodiments, in addition to polytetramethylene ether glycol (PTMG) residues, the balance of the glycol component of the polyesterether is essentially 1,4-cyclohexanedimethanol (CHDM) residues. In embodiments, the glycol component of the polyesterether comprises less than 10 mole %, or less than 5 mole %, or less than 2 mole %, or less than 1 mole %, of glycol residues other than residues of CHDM and PTMG.

In embodiments, the polyesterether can comprise residues of from 50 weight % to 95 weight %, or from 55 weight % to 95 weight %, or from 60 weight % to 95 weight %, or from 70 weight % to 95 weight %, or from 75 weight % to 95 weight %, or from 80 weight % to 95 weight %, of 1,4-cyclohexanedimethanol residues. In embodiment, the polyesterether does not contain residues of ethylene glycol.

In embodiments, the second layer can comprise a polyesterether having an inherent viscosity (IV) in a range from 0.70 to 1.5 dL/g, or 0.8 to 1.4 dL/g, or 0.9 to 1.3 dL/g, 1.0 to 1.2 dL/g, or 1.1 to 1.2 dL/g, or 1.14 to 1.18 dL/g, as determined in 60/40 (wt/wt) phenol/tetrachloroethane at a concentration of 0.5 g/100 ml at 25° C. In embodiments, the polyesterether has a glass transition temperature (Tg) or less than 0° C., or less than −10° C., or less than −20° C., or less than −30° C., or in the range from −60° C. to 0° C., or −50° C. to −10° C., −60° C. to −20° C., or −50° C. to −30° C., measured by DSC. In embodiments, the polyesterether has an elongation at break of at least 200%, or at least 300%, or at least 350%, or in the range of 200% to 600%, or 300% to 500%, measured according to ASTM D 638; and/or a flexural modulus in the range of 50 to 250 MPa, or 100 to 200 MPa, measured according to ASTM D 790; and/or a tear strength of at least 200 N, or at least 250 N, or at least 300 N, or in the range from 200 N to 500N, or 250 N to 450 N, or 300 N to 400 N, measured according to ASTM D 1004.

In one embodiment, copolyesterether contained in the second layer can have an inherent viscosity of from about 0.70 to about 1.5 dL/g as determined in 60/40 (wt/wt) phenol/tetrachloroethane at a concentration of 0.5 g/100 ml at 25° C. and can comprise:
A. a dicarboxylic acid component comprising and/or consisting essentially of 1,4-cyclohexanedicarboxylic acid, and
B. a glycol component consisting essentially of
   (1) 1,4-cyclohexanedimethanol, and
   (2) from about 1 to about 50 mole percent, or from 1 to 20 mole percent, or from 1 to 15 mole percent, or from 2 to 10 mole percent, based on the moles of the glycol component of the polyesterether, of polytetramethyleneether glycol (PTMG) having a weight average molecular weight of about 500 to about 2000.

In one embodiment, the copolyesterether can further comprise (3) from about 0.1 to about 1.5 mole %, or 0.1 to 1.0 mole % based on the total mole % of the acid or glycol component, of a branching agent having at least three COOH or OH functional groups and from 3 to 60 carbon atoms. In embodiments, the branching agent can include one or more of the branching agents, and examples of same, as described herein regarding other polyesters.

In embodiments, the multilayer sheet (or film) is a three-layer structure having a core layer and two outer layers, one on each side of the core layer. In embodiments, the core layer contains the second layer composition and the outer layers are made from the first layer composition. In other embodiments, the core layer contains the first layer composition and the outer layers are made from the second layer composition.

As noted above, the overall thickness of the film can range from about 100 μm to about 3000 μm, or about 300 μm to about 3000 μm. In other embodiments, the thickness of the sheet ranges from about 380 μm to about 1600 μm, or about 500 μm to 1000 μm.

The single or multicomponent composition film can be produced by compounding and extrusion as well as other methods.

In embodiments for a film structure having at least three layers, the thickness of the core layer can range from about 1 μm to about 1000 μm. In certain embodiments, the thickness of the core layer ranges from about 1 μm to about 725 μm, or 1 μm to 600 μm. In certain embodiments, the thickness of the outer layers each individually range from about 1 μm to about 2000 μm. In a further embodiment, the outer layer thickness ranges from about 25 μm to about 2000 μm.

In embodiments, the multilayer sheet has a total thickness in the range from 100 to 1050 microns, or 500 to 1050 microns, or 500 to 1000 microns, or 600 to 900 microns, or 600 to 800 microns, or 635 microns (25 mils) to 889 microns (35 mils), or 635 microns (25 mils) to 762 microns (30 mils). In embodiments, the thickness of the second layer is from 10 to 75%, or 10 to 70%, or 10 to 65%, or 10 to 60%, or 10 to 55%, or 10 to 50%, or 15 to 45%, or 20 to 40%, or 20 to 35%, or 25 to 35% of the total thickness of the multilayer sheet. In embodiments, the thickness of the second layer is from 20 to 75%, or 20 to 70%, or 20 to 65%, or 20 to 60%, or 20 to 55%, or 20 to 50%, or 25 to 75%, or 25 to 70%, or 25 to 65%, or 25 to 60%, or 25 to 55%, or 25 to 50%, or 30 to 75%, or 30 to 70%, or 30 to 65%, or 30 to 60%, or 30 to 55%, or 30 to 50%, or 35 to 75%, or 35 to 70%, or 35 to 65%, or 35 to 60%, or 35 to 55%, or 35 to 50% of the total thickness of the multilayer sheet.

Multilayer films can be produced by co-extrusion, extrusion laminating, heat laminating, adhesive laminating and the like. In co-extrusion multiple layers of polymers are generated by melting the polymer compositions for each layer in different extruders which are fed into a coextrusion block or die. A multi-layer sheet or film is formed in the block or die. Extrusion laminating is a process in which at least two sheets or films (monolayer or co-ex) are bonded together by extruding a polymer melt between them, creating a multilayer structure. Adhesive laminating takes at least two sheets or films (monolayer or co-ex) and bonds them together using a liquid adhesive to create a multilayer sheet or film. Heat laminating is a batch process in which cut sheets or films of various compositions or structures are laid up in a heated press. Multiple combinations and multiple layers can be made using these methods.

In the event a multilayer film having a core and outer layers as described herein tend to separate or delaminate from each other during processing or usage, at least one intermediate “tie layer” may be utilized between such layers. In one embodiment, the multilayer film has at least five film layers comprising one-core layer A and two outer layers B, with one-layer B one each side of the core layer A and a tie layer between the layer A and each layer B, i.e., “B-tie-A-tie-B”. In certain embodiments, such tie layers can comprise one or more copolymers selected from polyethylene copolymers, polypropylene copolymers, anhydride modified polyolefins, acid/acrylate modified ethylene vinyl acetate copolymer, acid modified ethylene acrylate, anhydride modified ethylene acrylate, modified ethylene acrylate, modified ethylene vinyl acetate, anhydride modified ethylene vinyl acetate copolymer, anhydride modified high density polyethylene, anhydride modified linear low density polyethylene, anhydride modified low density polyethylene, anhydride modified polypropylene, ethylene ethyl acrylate maleic anhydride copolymer and ethylene butyl acrylate maleic anhydride terpolymer, ethylene-alpha-olefin copolymers, alkene-unsaturated carboxylic acid or carboxylic acid derivative copolymers, ethylene-methacrylic acid copolymers, ethylene-vinyl acetate copolymers, ethylene-methacrylic acid copolymers, unsaturated dicarboxylic acid anhydride grafted copolymers, maleic anhydride grafted ethylene-vinyl acetate copolymers, maleic anhydride grafted polyethylene, styrene-butadiene copolymers, C3 or higher alpha-olefin copolymers having a high alpha-olefin comonomer content, propylene-1-butene copolymers, and mixtures thereof.

In embodiments, the film (e.g., mono-layer or multilayer film, depending on the embodiment) has an average tear propagation resistance of at least 30 N/mm, or at least 31 N/mm, or at least 32 N/mm, or at least 33 N/mm, or at least 34 N/mm, or at least 35 N/mm, or at least 36 N/mm, or at least 37 N/mm, or at least 38 N/mm, or at least 39 N/mm, or at least 40 N/mm, or at least 45 N/mm, or at least 50 N/mm, or at least 60 N/mm, or at least 70 N/mm, or in a range from 30 N/mm to 100 N/mm, or 30 N/mm to 80 N/mm, or 30 N/mm to 60 N/mm, or 30 N/mm to 55 N/mm, or 30 N/mm to 50 N/mm, 35 N/mm to 100 N/mm, or 35 N/mm to 80 N/mm, or 35 N/mm to 60 N/mm, or 35 N/mm to 55 N/mm, or 35 N/mm to 50 N/mm, 40 N/mm to 100 N/mm, or 40 N/mm to 80 N/mm, or 40 N/mm to 60 N/mm, or 40 N/mm to 55 N/mm, or 40 N/mm to 50 N/mm, or 50 N/mm to 100 N/mm, or 50 N/mm to 80 N/mm, or 50 N/mm to 70 N/mm, or 50 N/mm to 60 N/mm, or 60 N/mm to 100 N/mm, or 60 N/mm to 80 N/mm, or 60 N/mm to 70 N/mm, in the machine direction measured according to ASTM D 1938. In embodiments, the film (e.g., mono-layer or multilayer film, depending on the embodiment) has an average tear propagation resistance of at least 30 N/mm, or at least 31 N/mm, or at least 32 N/mm, or at least 33 N/mm, or at least 34 N/mm, or at least 35 N/mm, or at least 36 N/mm, or at least 37 N/mm, or at least 38 N/mm, or at least 39 N/mm, or at least 40 N/mm, or at least 45 N/mm, or at least 50 N/mm, or at least 60 N/mm, or at least 70 N/mm, or at least 80 N/mm, or in a range from 30 N/mm to 100 N/mm, or 30 N/mm to 80 N/mm, or 30 N/mm to 60 N/mm, or 30 N/mm to 55 N/mm, or 30 N/mm to 50 N/mm, 35 N/mm to 100 N/mm, or 35 N/mm to 80 N/mm, or 35 N/mm to 60 N/mm, or 35 N/mm to 55 N/mm, or 35 N/mm to 50 N/mm, 40 N/mm to 100 N/mm, or 40 N/mm to 80 N/mm, or 40 N/mm to 60 N/mm, or 40 N/mm to 55 N/mm, or 40 N/mm to 50 N/mm, or 50 N/mm to 100 N/mm, or 50 N/mm to 80 N/mm, or 50 N/mm to 70 N/mm, or 50 N/mm to 60 N/mm, or 60 N/mm to 100 N/mm, or 60 N/mm to 80 N/mm, or 60 N/mm to 70 N/mm, or 70 N/mm to 100 N/mm, or 70 N/mm to 80 N/mm, in the transverse direction measured according to ASTM D 1938. In embodiments, the film (e.g., mono-layer or multilayer film, depending on the embodiment) has an average tear propagation resistance of at least 30 N/mm, or at least 31 N/mm, or at least 32 N/mm, or at least 33 N/mm, or at least 34 N/mm, or at least 35 N/mm, or at least 36 N/mm, or at least 37 N/mm, or at least 38 N/mm, or at least 39 N/mm, or at least 40 N/mm, or at least 45 N/mm, or at least 50 N/mm, or at least 60 N/mm, or at least 70 N/mm, or in a range from 30 N/mm to 100 N/mm, or 30 N/mm to 80 N/mm, or 30 N/mm to 60 N/mm, or 30 N/mm to 55 N/mm, or 30 N/mm to 50 N/mm, 35 N/mm to 100 N/mm, or 35 N/mm to 80 N/mm, or 35 N/mm to 60 N/mm, or 35 N/mm to 55 N/mm, or 35 N/mm to 50 N/mm, 40 N/mm to 100 N/mm, or 40 N/mm to 80 N/mm, or 40 N/mm to 60 N/mm, or 40 N/mm to 55 N/mm, or 40 N/mm to 50 N/mm, or 50 N/mm to 100 N/mm, or 50 N/mm to 80 N/mm, or 50 N/mm to 70 N/mm, or 50 N/mm to 60 N/mm, or 60 N/mm to 100 N/mm, or 60 N/mm to 80 N/mm, or 60 N/mm to 70 N/mm, in both the machine and transverse direction measured according to ASTM D 1938.

In embodiments, the film (e.g., mono-layer or multilayer film, depending on the embodiment) has an average tear propagation resistance of at least 30 N/mm, or at least 31 N/mm, or at least 32 N/mm, or at least 33 N/mm, or at least 34 N/mm, or at least 35 N/mm, or at least 36 N/mm, or at least 37 N/mm, or at least 38 N/mm, or at least 39 N/mm, or at least 40 N/mm, or at least 45 N/mm, or at least 50 N/mm, or at least 60 N/mm, or at least 70 N/mm, or in a range from 30 N/mm to 100 N/mm, or 30 N/mm to 80 N/mm, or 30 N/mm to 60 N/mm, or 30 N/mm to 55 N/mm, or 30 N/mm to 50 N/mm, 35 N/mm to 100 N/mm, or 35 N/mm to 80 N/mm, or 35 N/mm to 60 N/mm, or 35 N/mm to 55 N/mm, or 35 N/mm to 50 N/mm, 40 N/mm to 100 N/mm, or 40 N/mm to 80 N/mm, or 40 N/mm to 60 N/mm, or 40 N/mm to 55 N/mm, or 40 N/mm to 50 N/mm, or 50 N/mm to 100 N/mm, or 50 N/mm to 80 N/mm, or 50 N/mm to 70 N/mm, or 50 N/mm to 60 N/mm, or 60 N/mm to 100 N/mm, or 60 N/mm to 80 N/mm, or 60 N/mm to 70 N/mm, in both the machine and transverse direction measured according to ASTM D 1938; and/or a force retention of 70% or less, or 50% or less, or 30% or less, or a range of 5 to 70%, or 5 to 50%, or 10 to 50%, or 20 to 40%, measured as described in the examples herein; and/or a flexural modulus greater than 1000 MPa, or at least 1200 MPa, or at least 1500 MPa, or in the range of greater than 1000 to 2400 MPa, or greater than 1000 to 2200 MPa, or greater than 1200 to 2400 MPa, or greater than 1200 to 2200 MPa, or greater than 1500 to 2400 MPa, or greater than 1500 to 2200 MPa, or 1600 to 2400 MPa, or 1600 to 2200 MPa, or 1600 to 2000 MPa, or 1700 to 2400 MPa, or 1700 to 2200 MPa, or 1700 to 2000 MPa, or 1800 to 2400 MPa, or 1800 to 2300 MPa, or 1800 to 2200 MPa, or 1800 to 2000 MPa, or 1900 to 2400 MPa, or 1900 to 2300 MPa, or 1900 to 2200 MPa, or 1900 to 2000 MPa, or 2000 to 2400 MPa, or 2000 to 2300 MPa, or 2000 to 2200 MPa, or 2100 to 2400 MPa, or 2100 to 2300 MPa, or 2200 to 2400 MPa, measured according to ASTM D 790. In embodiments, the multilayer sheet has both the tear force and force retention properties described above. In embodiments, the film has each of the tear force, force retention and flexural modulus properties described above. The force retention properties of the examples were analyzed using dynamic mechanical analysis (DMA) in tensile mode on a film sample of thickness 0.7-0.8 mm and width of 3.1-3.3 mm. The samples were held for 24 hours at 0.5% strain, during which time the stress was monitored. This testing was performed at 37° C. with a relative humidity of 90-100% (which can include testing while submerged in water).

In embodiments, the film has a total thickness in the range from 100 to 1050 microns, or 500 to 1050 microns, or 500 to 1000 microns, or 600 to 900 microns, or 600 to 800 microns, or 635 microns (25 mils) to 889 microns (35 mils), or 635 microns (25 mils) to 762 microns (30 mils). In embodiments for a multilayer film, the thickness of the inner (or core layer) can be from 10 to 50%, or 15 to 45%, or 20 to 40%, or 20 to 35%, or 25 to 35% of the total thickness of the multilayer film.

Due to its structure as having customizable modulus and superior tear resistance, the films are useful in preparing removable dental appliances, e.g., removable orthodontic tooth positioning appliances, insofar as the films possess sufficiently high modulus and superior tear resistance. See for example, U.S. Pat. Nos. 9,655,691; 9,655,693; and 10,052,176, incorporated herein by reference.

Accordingly, in an embodiment, the invention provides a removable dental appliance having one or more teeth receiving cavities shaped to receive at least some of a patient's teeth, said appliance comprising a polymer structure formed from any of the films described herein.

In a further embodiment, the invention provides a removable orthodontic tooth positioning appliance having teeth receiving cavities shaped to directly receive at least some of a patient's teeth, said appliance comprising a polymer structure formed from a film comprising a single or multicomponent composition comprising at least one polymeric component (A) and optionally a polymeric component (B), wherein polymeric component (A) is present in an amount from 40 to 100 wt %, or 50 to 100 wt % and polymeric component (B) is present in an amount from 0 to 60 wt %, or 0 to 50 wt %; and wherein polymeric component (A) comprises a polyester that comprises:
(a) a dicarboxylic acid component comprising:
   i) 1 to 100 mole % of isophthalic acid residues; and
   ii) 0 to 99 mole % of terephthalic acid residues; and
   iii) 0 to 25 mole % of a different aromatic and/or aliphatic dicarboxylic acid residues having up to 20 carbon atoms; and
(b) a glycol component comprising:
   i) 1 to 100 mole % of 1,4-cyclohexanedimethanol residues; and
   ii) 0 to 99 mole % of ethylene glycol residues; and
   iii) 0 to 25 mole % of a different aromatic and/or aliphatic modifying glycol residues;
having an inherent viscosity of about 0.4 to about 1.1 dL/g as determined in 60/40 (wt/wt) phenol/tetrachloroethane at a concentration of 0.5 g/100 ml at 25° C.; and polymeric component (B) comprises a polyester which is other than the polyester in polymeric component (A), and where the film has an average tear propagation resistance greater than 30 N/mm, or greater than 35 N/mm, or greater than 40 N/mm in both the machine and transverse direction when measured according to ASTM D 1938; and
   where the multicomponent film has a haze value less than 30%, or less than 20% when measured according to ASTM D 1003 on a 0.75 mm film, and wherein the overall thickness of the film is between 100 and 3000 microns, or 300 and 3000 microns.

In a further embodiment, said polymeric component (A) comprises a polyester comprising:
(a) a dicarboxylic acid component comprising:
   i) 1 to 100 mole % of isophthalic acid residues; and
   ii) 0 to 99 mole % of terephthalic acid residues;
(b) a glycol component comprising:
   i) 1 to 100 mole % of 1,4-cyclohexanedimethanol residues; and
   ii) 0 to 99 mole % of ethylene glycol residues;
having an inherent viscosity of about 0.4 to about 1.1 dL/g as determined in 60/40 (wt/wt) phenol/tetrachloroethane at a concentration of 0.5 g/100 ml at 25° C.

In a further embodiment, said polymeric component (A) comprises a polyester comprising:
(a) a dicarboxylic acid component comprising:
   i) 1 to 50 mole % of isophthalic acid residues; and
   ii) 50 to 99 mole % of terephthalic acid residues;
(b) a glycol component comprising:
   i) 1,4-cyclohexanedimethanol residues;
having an inherent viscosity of about 0.4 to about 1.1 dL/g as determined in 60/40 (wt/wt) phenol/tetrachloroethane at a concentration of 0.5 g/100 ml at 25° C. In a further embodiment, the inherent viscosity of the polymeric component (A) is between about 0.6 and 0.8 dL/g.

In embodiments, the film comprising a multicomponent composition used to form the appliance can include any of the film embodiments described herein and any of the combinations of polymeric components (A) and (B) for two (or more) component compositions or any of the combinations of polymeric components (A), (B) and (C) for three (or more) component compositions.

In a further embodiment, the invention provides a removable orthodontic tooth positioning appliance having teeth receiving cavities shaped to directly receive at least some of a patient's teeth, said appliance comprising a multi-layer polymer structure formed from a film comprising two outer layers and at least one core layer, wherein at least one layer comprises the multicomponent composition described herein.

In embodiments, the dental appliance can be made from any of the monolayer or multilayer films described herein.

This invention can be further illustrated by the following examples of certain embodiments thereof, although it will be understood that these examples are included merely for purposes of illustration and are not intended to limit the scope of the invention unless otherwise specifically indicated.

### EXAMPLES

The following examples are provided illustrate certain embodiments of the invention.

### Film Sample Preparation

All blends were compounded on a 26 mm twin-screw extruder and strand-pelletized prior to film extrusion. Compounding barrel and die temperatures ranged from 260-270° C. Film samples were extruded on a 1.5″ single-screw extruder with target film thickness of 0.7-0.8 mm. Film extrusion barrel temperature was 260-270° C. All materials were dried prior to compounding and extrusion. Properties provided were tested using the methods outlined in the “Test Methods” described herein.

### Test Methods

The tensile properties of the examples were determined using a test method derived from ASTM D882. Film thickness was 0.7 to 0.8 mm. Small Type V tensile bars were cut from the film. Samples were conditioned for at least 40 hours and tested at 23° C./50% relative humidity unless otherwise stated. A crosshead speed of 1.27 mm/min was used.

The flexural properties of the examples were determined using a test method derived from ASTM D790 Procedure A. Film thickness was 0.7 to 0.8 mm. Films were conditioned for 40 hours and tested at 23° C./50% relative humidity unless otherwise stated. A crosshead speed of 1.27 mm/min was used.

The tear propagation resistance of the examples was determined using a test method derived from ASTM D1938. Film thickness was 0.7 to 0.8 mm. Films were conditioned for 40 hours and tested at 23° C./50% relative humidity unless otherwise stated. Load was applied at 250 mm per minute.

The hardness of the examples was determined using a test method derived from ASTM D2240. Film thickness was 0.7 to 0.8 mm and the samples were stacked if necessary to reach the required test thickness. Samples were conditioned for at least 40 hours and tested at 23° C./50% relative humidity unless otherwise stated.

Unless otherwise specified, L*, a* and b* were determined according to ASTM E 1348 and ASTM E308 on a 0.75 mm film.

Unless otherwise specified, % haze and transmission were determined according to ASTM D 1003 on a 0.75 mm film.

Unless otherwise specified, glass transition temperature (Tg) was determined using a TA DSC 2920 from Thermal Analyst Instrument at a scan rate of 20° C./min on a sample dried in a vacuum oven for 24 hours prior to testing.

Unless otherwise specified, force retention properties were analyzed using dynamic mechanical analysis (DMA) in tensile mode on a film sample of thickness 0.7-0.8 mm and width of 3.1-3.3 mm. The samples were held for 24 hours at 0.5% strain, during which time the stress was monitored. This testing was performed at 37° C. with a relative humidity of 90-100% (which can include testing while submerged in water).

### Examples

Materials used in the examples included:
R1—Durastar MN621 (Eastman Chemical Company)
R2—Durastar MN611 (Eastman Chemical Company)
R3—Eastar CN015 (Eastman Chemical Company)
R4—Neostar 19972 (Eastman Chemical Company)
R5—Tritan MP100 (Eastman Chemical Company)
R6—Tritan MP200 (Eastman Chemical Company)
R7—Tritan TX1800 (Eastman Chemical Company)
R8—Eastar MN210 (Eastman Chemical Company)
R9—Medstar (Eastman Chemical Company)

### Example 1

Table 1 provides examples comparing films produced from copolyesters R1, R2, and R3, as well as blends of R2 with copolyester R4. Copolyesters R1, R2 and R3 had diacid components that contained about 26 mole % IPA residues, 35 mole % IPA residues and 48 mole % IPA residues, respectively, based on the total mole % of the diacid residues for each copolyester. R4 was a polyester that had a diacid component that contained CHDA resides and did not contain any IPA residues.

### Comparative Example 2

Table 2 provides comparative examples of films produced from copolyesters R5 and R6, as well as blends of R5 with copolyester R4. Neither of copolyesters R5 or R6 contain IPA residues, but the diol residues contained in these copolyesters include TMCD residues.

TABLE 1
Properties for Examples

| | | EX 1-1 | 1-2 | 1-3 | 1-4 | 1-5 |
|---|---|---|---|---|---|---|
| Composition | R1 | 100% | | | | |
| (wt %) | R2 | | 100% | | 80% | 60% |
| | R3 | | | 100% | | |
| | R4 | | | | 20% | 40% |
| Tensile | Yield Stress, MPa | 45.9 | 39.8 | 47.4 | 43.5 | 41.4 |
| Properties | Yield Strain, % | 5.2 | 4.6 | 4.6 | 4.9 | 4.8 |
| | Break Stress, MPa | 50.6 | 45.8 | 39.1 | 46.4 | 47.4 |
| | Break Strain, % | 165 | 181 | 111 | 174 | 206 |
| Flexural | Modulus, MPa | 2017 | 2160 | 2292 | 2194 | 1988 |
| Properties | | | | | | |
| Hardness | Shore D | 79 | 77 | 79 | 74 | 76 |
| Trouser | Avg Tear Propagation | 50.4 | — | 51.6 | 67.0 | 96.7 |
| Tear | Resist - TD (N/mm) | | | | | |
| Force | Avg Tear Propagation | 51.2 | 51.7 | 51.0 | 40.5 | 61.0 |
| | Resist - MD (N/mm) | | | | | |

A review of Table 1 reveals that the films according to example 1 (single and multicomponent) can provide the ability to tune certain properties such as modulus while retaining a tear high tear resistance.

TABLE 2
Properties for Example 2

| | | CE 2-1 | 2-2 | 2-3 | 2-4 |
|---|---|---|---|---|---|
| Composition | R5 | 100% | | 80% | 60% |
| (wt %) | R6 | | 100% | | |
| Tensile | R4 | | | 20% | 40% |
| Properties | Yield Stress, MPa | 45.3 | 42.3 | 34.8 | 38.4 |
| | Yield Strain, % | 5.2 | 6.3 | 4.4 | 4.4 |
| | Break Stress, MPa | 60.1 | 41.7 | 44.9 | 49.3 |
| | Break Strain, % | 92 | 59 | 125 | 159 |
| Flexural | Modulus, MPa | 2077 | 1834 | 1708 | 1627 |
| Properties | | | | | |
| Color | L* | 96.2 | — | 96.7 | 96.9 |
| | a* | 0.0 | — | 0.0 | 0.0 |
| | b* | 0.4 | — | 0.5 | 0.5 |
| | % Haze | 0.89 | — | 0.45 | 0.33 |
| Hardness | Shore D | 78 | 76 | 78 | 77 |
| Trouser | Avg Tear Propagation | — | — | — | — |
| Tear | Resist - TD (N/mm) | | | | |
| Force | Avg Tear Propagation | 27.7 | 22.7 | 29.9 | 37.2 |
| | Resist - MD (N/mm) | | | | |

A review of Table 2 reveals that the comparative examples according to example 2 exhibit lower tear propagation resistance compared to the examples in Table 1 according to example 1.

### Example 3

Table 3 provides examples comparing films produced from blends of R1 with polyester R5; R2 with polyesters R5, R8, and R9, respectively; and R3 with polyester R5. Polyester R8 had a diacid component that did not contain any IPA residues and a diol component that contained diol residues with a majority of ethylene glycol (EG) residues and minority of CHDM residues. Polyester R9 had a diacid component that did not contain any IPA residues and a diol component that contained diol residues with of a majority of CHDM residues and minority of EG residues.

TABLE 3
Properties for Example 3

| | | EX 3-1 | 3-2 | 3-3 | 3-4 | 3-5 |
|---|---|---|---|---|---|---|
| Composition | R1 | | 50% | | | |
| (wt %) | R2 | 50% | | | 50% | 50% |
| | R3 | | | 50% | | |
| | R5 | 50% | 50% | 50% | | |
| | R8 | | | | 50% | |
| | R9 | | | | | 50% |
| Tensile | Yield Stress, MPa | 44.5 | 44.2 | 46.8 | 47.7 | 44.4 |
| Properties | Yield Strain, % | 5.3 | 5.3 | 5.3 | 5.1 | 5.1 |
| | Break Stress, MPa | 59.2 | 60.0 | 57.3 | 55.2 | 57.4 |
| | Break Strain, % | 152 | 152 | 147 | 216 | 202 |
| Flexural | Modulus, MPa | 1958 | 1952 | 2115 | 2257 | 2040 |
| Properties | | | | | | |
| Color | L* | 91.8 | 92.8 | 96.3 | 84.5 | 95.0 |
| | a* | 0.5 | 0.29 | 0.05 | 0.37 | 0.4 |
| | b* | 9.2 | 7.1 | 2.4 | 8.4 | 2.9 |
| | % Haze | 2.4 | 2.4 | 1.0 | 25.7 | 1.7 |
| Tg | Degree Celsius | 92.9 | 94.1 | 90.6 | 80.6 | 83.7 |
| Trouser | Avg Tear Propagation | 35.4 | 34.0 | 38.6 | 97.1 | 52.3 |
| Tear | Resist - TD (N/mm) | | | | | |
| Force | Avg Tear Propagation | 35.4 | 32.5 | 35.8 | 58.0 | 51.7 |
| | Resist - MD (N/mm) | | | | | |

A review of Table 3 reveals that the examples according to example 3 exhibited higher tear propagation resistance for the blends with R5 compared to the neat R5 (CE 2-1). Also, R2 blends according to examples 3-4 and 3-5 exhibited higher tear propagation resistance compared to the R2 blend of example 3-1.

### Example 4

Table 4 provides examples comparing films produced from blends of R2 with polyester R7 and R4 with R7. R7 did not contain IPA residues, but the diol residues contained in this copolyester included TMCD residues and residues of a multifunctional alcohol.

TABLE 4
Properties for Example 4

| | | EX 4-1 | 4-2 |
|---|---|---|---|
| Composition | R2 (610) | 50% | |
| (wt %) | R4 (G16) | | 50% |
| | R7 (TX1800) | 50% | 50% |
| Tensile | Yield Stress, MPa | 45.002 | 38.556 |
| Properties | Yield Strain, % | 5.39 | 5.15 |
| | Break Stress, MPa | 54.183 | 49.411 |
| | Break Strain, % | 131.207 | 163.738 |
| Flexural | Modulus, MPa | 2040.58 | 1690.2 |
| Properties | | | |
| Color | L* | 95.88 | 96.1 |
| | a* | 0.14 | 0.19 |
| | b* | 2.53 | 3.34 |
| | % Haze | 1.22 | 1.03 |
| Tg | Degree Celsius | 93.8 | 83.4 |
| Trouser | Avg Tear Propagation | 33.7 | 34.5 |
| Tear | Resist - TD (N/mm) | | |
| Force | Avg Tear Propagation | 34.0 | 37.6 |
| | Resist - MD (N/mm) | | |

A review of Table 4 reveals that examples 4-1 and 4-2 had relatively close tear propagation resistance, but 4-1 had higher modulus.

### Example 5

Table 5 provides examples comparing films produced from blends of R3 with different amounts of polyester R5.

TABLE 5
Properties for Example 5

| | | EX 5-1 | 5-2 | 5-3 | 5-4 | 5-5 |
|---|---|---|---|---|---|---|
| Composition | R3 | 20% | 40% | 50% | 60% | 80% |
| (wt %) | R5 | 80% | 60% | 50% | 40% | 20% |
| Tensile | Yield Stress, MPa | 33.5 | 35.1 | 35.6 | 36.9 | 37.3 |
| Properties | Yield Strain, % | 5.2 | 5.2 | 4.9 | 5.0 | 5.0 |
| | Break Stress, MPa | 41.2 | 40.1 | 38.8 | 37.1 | 33.6 |
| | Break Strain, % | 121 | 128 | 130 | 123 | 124 |
| Flexural | Modulus, MPa | 1974 | 2061 | 2053 | 2126 | 2248 |
| Properties | | | | | | |
| Color | L* | 96.3 | 96.4 | 95.6 | 96.3 | 96.1 |
| | a* | −0.06 | −0.08 | −0.07 | −0.09 | −0.06 |
| | b* | 0.96 | 1.48 | 1.56 | 1.9 | 1.88 |
| | % Haze | 0.8 | 0.6 | 0.8 | 0.8 | 0.7 |
| Tg | Degree Celsius | 98.8 | 92.9 | 90.6 | 87.9 | 84.6 |
| Trouser | Avg Tear Propagation | 30.6 | 33.4 | 33.8 | 37.1 | 42.8 |
| Tear | Resist - TD (N/mm) | | | | | |
| Force | Avg Tear Propagation | 26.1 | 31.6 | 32.9 | 36.3 | 42.1 |
| | Resist - MD (N/mm) | | | | | |

A review of Table 5 reveals that blends having at least 40 wt % R3 exhibited higher tear propagation resistance and comparable or higher modulus compared to the neat R5 (CE 2-1), with higher tear propagation resistance for higher amounts of R3.

### Example 6

Table 6 provides examples comparing films produced from blends of R2 with different amounts of polyester R5 and with different amount of R7. The monolayer films described in Table 6 were prepared using pellet/pellet blends of resins in the ratios described in Table 6. The pellets were blended to the proper ratio and then dried overnight using a desiccant drier. Monolayer films of each blended resin sample were then extruded on a 1.5″ single-screw extruder with target film thickness of 0.7-0.8 mm. Film extrusion barrel temperature was 260-270° C. Properties provided were tested using the methods outlined in the “Test Methods” described herein.

TABLE 6
Properties for Example 6

| | | 6-1 | 6-2 | 6-3 | 6-4 | 6-5 | 6-6 |
|---|---|---|---|---|---|---|---|
| Composition | R5 | 60 | 50 | 40 | | | |
| | R2 | 40 | 50 | 60 | 40 | 50 | 60 |
| | R7 | | | | 60 | 50 | 40 |
| Tensile | Yield Stress, MPa | 43.9 | 44.8 | 44.9 | 45.1 | 45.6 | 46.1 |
| Properties | Yield Strain, % | 5.4 | 5.4 | 5.5 | 5.5 | 5.2 | 5.3 |
| | Break Stress, MPa | 58.2 | 60.1 | 55.7 | 58.9 | 59.0 | 61.1 |
| | Break Strain, % | 134 | 152 | 149 | 132 | 147 | 163 |
| Flexural | Modulus, MPa | 1823 | 1884 | 1888 | 1831 | 1846 | 1913 |
| Properties | | | | | | | |
| Color | L* | 96.6 | 96.8 | 96.7 | 96.7 | 96.7 | 96.7 |
| | a* | 0.09 | 0.07 | 0.07 | 0.06 | 0.1 | 0.1 |
| | b* | 0.63 | 0.97 | 0.65 | 0.56 | 0.72 | 1.1 |
| | % Haze | 2.0 | 0.72 | 1.1 | 0.93 | 0.65 | 0.94 |
| Tg | Degree Celsius | | | | | | |
| Trouser | Avg Tear Propagation | 31.1 | 35.8 | 40.0 | 28.8 | 35.9 | 38.8 |
| Tear | Resist - TD (N/mm) | | | | | | |
| Force | Avg Tear Propagation | 30.6 | 34.6 | 38.6 | 28.8 | 33.1 | 37.0 |
| | Resist - MD (N/mm) | | | | | | |
| Force | Initial Force (MPa) | 6.7 | 6.8 | 7.0 | 6.8 | 7.0 | 7.1 |
| Retention | % Force retained | 27 | 23 | 23 | 29 | 26 | 24 |

A review of Table 6 reveals that the blends with R5 and R7 had relatively similar results, but where the R5 blends exhibited typically higher tear propagation resistance and R7 blends exhibited typically higher force retention.

The invention has been described in detail with particular reference to certain embodiments thereof, but it will be understood that variations and modifications can be affected within the spirit and scope of the invention.

1. A film comprising a copolyester that comprises:
(a) a dicarboxylic acid component comprising:
i) 1 to 100 mole % of isophthalic acid residues; and
ii) 0 to 99 mole % of terephthalic acid residues; and
iii) 0 to 25 mole % of a different aromatic and/or aliphatic dicarboxylic acid residues having up to 20 carbon atoms; and
(b) a glycol component comprising:
i) 1 to 100 mole % of 1,4-cyclohexanedimethanol residues; and
ii) 0 to 99 mole % of a different aromatic and/or aliphatic modifying glycol residues having up to 20 carbon atoms; and
having an inherent viscosity of about 0.4 to about 1.1 dL/g as determined in 60/40 (wt/wt) phenol/tetrachloroethane at a concentration of 0.5 g/100 ml at 25° C.; and
having an average tear propagation resistance greater than 30 N/mm, in both the machine and transverse direction when measured according to ASTM D 1938; and
a haze value less than 30%, when measured according to ASTM D 1003 on a 0.75 mm film; and
wherein the overall thickness of the film is between 100 and 3000 microns.

2. The film according to claim 1, wherein the copolyester comprises:
(a) a dicarboxylic acid component comprising:
i) 1 to 100 mole % of isophthalic acid residues; and
ii) 0 to 99 mole % of terephthalic acid residues;
(b) a glycol component comprising:
i) 1 to 100 mole % of 1,4-cyclohexanedimethanol residues; and
ii) 0 to 99 mole % of ethylene glycol residues;
having an inherent viscosity of about 0.4 to about 1.1 dL/g as determined in 60/40 (wt/wt) phenol/tetrachloroethane at a concentration of 0.5 g/100 ml at 25° C.; and
having an average tear propagation resistance greater than 30 N/mm, in both the machine and transverse direction when measured according to ASTM D 1938; and
a haze value less than 30%, when measured according to ASTM D 1003 on a 0.75 mm film; and
wherein the overall thickness of the film is between 100 and 3000 microns.

3. The film according to claim 1, wherein the copolyester comprises:
(a) a dicarboxylic acid component comprising:
i) 1 to 50 mole % of isophthalic acid residues; and
ii) 50 to 99 mole % of terephthalic acid residues;
(b) a glycol component comprising:
i) 1,4-cyclohexanedimethanol residues;
having an inherent viscosity of about 0.4 to about 1.1 dL/g as determined in 60/40 (wt/wt) phenol/tetrachloroethane at a concentration of 0.5 g/100 ml at 25° C.; and
having an average tear propagation resistance greater than 30 N/mm, in both the machine and transverse direction when measured according to ASTM D 1938; and
a haze value less than 30%, when measured according to ASTM D 1003 on a 0.75 mm film; and
wherein the overall thickness of the film is between 100 and 3000 microns.

4. A film comprising a multicomponent composition that comprises at least two polymeric components (A) and (B), wherein polymeric component (A) is present in an amount from 40 to 99 wt %, and polymeric component (B) is present in an amount from 1 to 60 wt %; and wherein
polymeric component (A) comprises a polyester that comprises:
(a) a dicarboxylic acid component comprising:
i) 1 to 100 mole % of isophthalic acid residues; and
ii) 0 to 99 mole % of terephthalic acid residues; and
iii) 0 to 25 mole % of a different aromatic and/or aliphatic dicarboxylic acid residues having up to 20 carbon atoms; and
(b) a glycol component comprising:
i) 50 to 100 mole % of 1,4-cyclohexanedimethanol residues; and
ii) 0 to 50 mole % of ethylene glycol residues; and
iii) 0 to 25 mole % of a different aromatic and/or aliphatic modifying glycol residues;
having an inherent viscosity of about 0.4 to about 1.1 dL/g as determined in 60/40 (wt/wt) phenol/tetrachloroethane at a concentration of 0.5 g/100 ml at 25° C.; and
polymeric component (B) comprises a polyester which is other than the polyester in polymeric component (A); and
where the multicomponent film has an average tear propagation resistance greater than 30 N/mm, in both the machine and transverse direction when measured according to ASTM D 1938; and
where the multicomponent film has a haze value less than 30%, when measured according to ASTM D 1003 on a 0.75 mm film; and
wherein the overall thickness of the film is between 100 and 3000 microns.

5. The film according to claim 4, wherein the polymeric component (A) comprises:
(a) a dicarboxylic acid component comprising:
i) 1 to 100 mole % of isophthalic acid residues; and
ii) 0 to 99 mole % of terephthalic acid residues; and
(b) a glycol component comprising:
i) 50 to 100 mole % of 1,4-cyclohexanedimethanol residues; and
ii) 0 to 50 mole % of ethylene glycol residues; and
has an inherent viscosity of about 0.4 to about 1.1 dL/g as determined in 60/40 (wt/wt) phenol/tetrachloroethane at a concentration of 0.5 g/100 ml at 25° C.

6. The film according to claim 4, wherein the polymeric component (A) comprises:
(a) a dicarboxylic acid component comprising:
(a) a dicarboxylic acid component comprising:
i) 1 to 50 mole % of isophthalic acid residues; and
ii) 50 to 99 mole % of terephthalic acid residues;
(b) a glycol component comprising:
i) 100 mole % 1,4-cyclohexanedimethanol residues; and
has an inherent viscosity of about 0.4 to about 1.0 dL/g as determined in 60/40 (wt/wt) phenol/tetrachloroethane at a concentration of 0.5 g/100 ml at 25° C.

7. The film according to claim 4, wherein the polymeric component (B) comprises:
(a) a dicarboxylic acid component comprising:
i) 50 to 100 mole % of terephthalic acid residues;
ii) 0 to 50 mole % of isophthalic acid residues; and
(b) a glycol component comprising:
i) 1 to 100 mole % of 1,4-cyclohexanedimethanol residues; and
ii) 0 to 99 mole % of ethylene glycol residues; and
has an inherent viscosity of about 0.4 to about 1.0 dL/g as determined in 60/40 (wt/wt) phenol/tetrachloroethane at a concentration of 0.5 g/100 ml at 25° C.

8. The film according to claim 4, wherein the polymeric component (B) comprises:
(a) a dicarboxylic acid component comprising:
i) 50 to 100 mole % of terephthalic acid residues;
ii) 0 to 50 mole % of isophthalic acid residues; and
(b) a glycol component comprising:
i) 30 to 100 mole % of 1,4-cyclohexanedimethanol residues; and
ii) 0 to 70 mole % of ethylene glycol residues; and
has an inherent viscosity of about 0.4 to about 0.9 dL/g as determined in 60/40 (wt/wt) phenol/tetrachloroethane at a concentration of 0.5 g/100 ml at 25° C.

9. The film according to claim 4, wherein the polymeric component (B) comprises:
(a) a dicarboxylic acid component comprising:
i) 50 to 100 mole % of terephthalic acid residues;
ii) 0 to 50 mole % of isophthalic acid residues; and
(b) a glycol component comprising:
i) 30 to 100 mole % of 1,4-cyclohexanedimethanol residues; and
ii) 0 to 70 mole % of 2,2,4,4-tetramethyl-1,3-cyclobutanediol residues; and
has an inherent viscosity of about 0.4 to about 0.9 dL/g as determined in 60/40 (wt/wt) phenol/tetrachloroethane at a concentration of 0.5 g/100 ml at 25° C.

10. The film according to claim 4, wherein the polymeric component (B) comprises:
(a) a dicarboxylic acid component comprising:
i) 50 to 100 mole % of terephthalic acid residues;
ii) 0 to 50 mole % of isophthalic acid residues; and
(b) a glycol component comprising:
i) 60 to 100 mole % of 1,4-cyclohexanedimethanol residues; and
ii) 0 to 40 mole % of 2,2,4,4-tetramethyl-1,3-cyclobutanediol residues; and
has an inherent viscosity of about 0.4 to about 0.9 dL/g as determined in 60/40 (wt/wt) phenol/tetrachloroethane at a concentration of 0.5 g/100 ml at 25° C.

11. The film according to claim 4, wherein the polymeric component (B) comprises:
(a) a dicarboxylic acid component comprising:
i) 1 to 100 mole % of 1,4-cyclohexane dicarboxylic acid residues;
ii) 0 to 99 mole % of terephthalic acid residues; and
(b) a glycol component comprising:
i) 50 to 100 mole % of 1,4-cyclohexanedimethanol residues; and
ii) 0 to 50 mole % of one or more different aromatic and/or aliphatic modifying glycol residues; and
has an inherent viscosity of about 0.4 to about 1.2 dL/g as determined in 60/40 (wt/wt) phenol/tetrachloroethane at a concentration of 0.5 g/100 ml at 25° C.

12. The film according to claim 4, wherein the polymeric component (B) comprises:
(a) a dicarboxylic acid component comprising:
i) 1,4-cyclohexane dicarboxylic acid residues; and
(b) a glycol component comprising:
i) 1,4-cyclohexanedimethanol residues; and
has an inherent viscosity of about 0.4 to about 1.2 dL/g as determined in 60/40 (wt/wt) phenol/tetrachloroethane at a concentration of 0.5 g/100 ml at 25° C.

13. The film according to claim 4, wherein the film has a total thickness from about 500 μm to about 1000 μm.

14. The film according to claim 4, wherein the film has an average tear propagation resistance greater than 35 N/mm in both the machine and transverse direction when measured according to ASTM D 1938.

15. The film according to claim 4, wherein the film has a flexural modulus from about 1200 to 2400 MPa, measured according to ASTM D 790.

16. The film according to claim 15, wherein the film has a flexural modulus from about 1600 to 2300 MPa, measured according to ASTM D 790.

17. The film according to claim 4, wherein the film comprises 0.1 to 20% by weight modifying fillers or additives chosen from inorganic fillers, colorants, dyes, slip or release agents, anti-block aids, friction modifiers, rheology modifiers, impact modifiers, and/or stabilizers such as thermal or UV stabilizers.

18. The film according to claim 4, wherein the multicomponent composition of the film has a glass transition (Tg) of at least 60° C.

19. A removable dental appliance having at least one teeth receiving cavity shaped to receive at least some of a patient's teeth, said appliance comprising a film according to claim 4.

20. A removable orthodontic tooth positioning appliance having teeth receiving cavities shaped to directly receive at least some of a patient's teeth, said appliance comprising a film according to claim 4.
